(19) United States
(12) Patent Application Publication
(10) Pub. No.: US 2025/0023675 A1
(43) Pub. Date: Jan. 16, 2025

(54) SYSTEMS AND METHODS FOR DATA TRANSMISSION AND SECURITY

(71) Applicant: Focus Universal Inc., Ontario, CA (US)

(72) Inventor: Desheng Wang, Diamond Bar, CA (US)

(21) Appl. No.: 18/904,852

(22) Filed: Oct. 2, 2024

Related U.S. Application Data
(63) Continuation-in-part of application No. 17/747,805, filed on May 18, 2022.
(63) Continuation-in-part of application No. 17/747,887, filed on May 18, 2022.
(63) Continuation-in-part of application No. 17/748,763, filed on May 19, 2022.
(63) Continuation-in-part of application No. 17/750,181, filed on May 20, 2022.
(60) Provisional application No. 63/190,410, filed on May 19, 2021.
(60) Provisional application No. 63/190,572, filed on May 19, 2021.
(60) Provisional application No. 63/190,604, filed on May 19, 2021.
(60) Provisional application No. 63/190,940, filed on May 20, 2021.

(51) Int. Cl. H04L 5/00

(52) U.S. Cl. CPC H04L 5/001; H04L 5/0048

(57) ABSTRACT

Disclosed is a system and method for transmitting more data on the same bandwidth as current wireless and wired schemes use. A method for transmitting data can use orthogonal frequency domain multiplexing by identifying a lowest frequency subcarrier in an orthogonal frequency division multiplexing bandwidth that includes 64 subcarriers. The method can include receiving the second, fourth, eighth, sixteenth, thirty-second, and sixty-fourth subcarriers using a bandpass filter and decoding the set of orthogonal functions for each of the second, fourth, eighth, sixteenth, thirty-second, and sixty-fourth subcarriers. The method can further include combining the decoded data to recover the transmitted data.

### CROSS-REFERENCE TO RELATED APPLICATIONS

The present application is a continuation-in-part of: (1) U.S. patent application Ser. No. 17/747,805 (FCUV-120), titled “SYSTEM AND METHOD FOR TRANSMITTING COMMANDS AND DATA VIA NATURAL LANGUAGE-BASED FORMATS”, which claims the benefit of U.S. Provisional Patent Application No. 63/190,410, filed May 19, 2021; (2) U.S. patent application Ser. No. 17/747,887 (FCUV-122), titled “DYNAMIC PASSWORD CIPHER”, which claims the benefit of priority to U.S. Provisional Patent Application No. 63/190,572, filed May 19, 2021; (3) U.S. patent application Ser. No. 17/748,763 (FCUV-123), titled “LOCAL FILE SECURITY”, which claims the benefit of priority to U.S. Provisional Patent Application No. 63/190,604, filed May 19, 2021; and (4) U.S. patent application Ser. No. 17/750,181 (FCUV-126), titled “METHOD AND APPARATUS FOR HIGH DATA RATE TRANSMISSION”, which claims the benefit of priority to U.S. Provisional Patent Application No. 63/190,940, filed May 20, 2021. The disclosure each of the above-referenced applications is hereby incorporated by reference in its entirety. Any and all applications for which a foreign or domestic priority claim is identified in the Application Data Sheet as filed with the present application are hereby incorporated by reference under 37 CFR 1.57.

### FIELD

The present disclosure relates to a method to provide universal interoperability of devices and applications across operating systems and computer languages. The present disclosure also relates to security for passwords on automated systems. The present disclosure also relates to local file security. The present disclosure also relates to encoding a signal in order to transmit data.

### BACKGROUND

Currently, when devices or applications are designed for use with an operating system, software is coded from scratch to allow the device or application to interoperate with the operating system. Further, the several devices may be placed on a network, and must communicate not just with one another, but with the cloud. Communication with the cloud may require additional code to interoperate with the computer language used to access the cloud. Thus, for a single device or application, thousands of lines of code in at least one language, and potentially in several computer languages, must be created for a single device or application to interoperate with, for example, a single operating system or computing environment. The requirement for thousands of lines of code is further driven by the fact that computer languages tend to have elements which are fundamental. That is, each element accomplishes little on its own, and thousands of lines of code are sometimes required even to achieve basic functions.

However, getting the device or application to simply interoperate with an operating system and the cloud is not enough. The operation must be secure, and that security must be built in to the coding. The requirement that the operation be secure means that the entirety of the created code must be examined. Almost certainly, the examiner finds portions of the code where changes must be made.

Often, when changes are made in the coding to address a first identified problem, there are unintended consequences, and a second problem, or even a third problem, is created. Of course, such iterations of coding, testing, and recoding slow progress and cost time and money. Ultimately, this makes the cost of design and testing high. For a device or system of minimum complexity it may take 3-5 years and $5 million to complete the design process. For a high complexity device or system, the design process may take 10 times longer and cost as much as 10 times more. Given the time frames involved, it is possible that the original design may be obsolete by the time it is operable. In such circumstances, no company is incentivized to innovate and design new products.

Even if the design and testing ultimately prove successful, the creation of code from scratch on a device or system meant to interoperate with a single operating system is an inefficient design process and the end product requires a significant amount of memory to store. Moreover, the code on the device or system may require updates each time the code of the operating system is updated. If the code on the device or of the application is not updated, the device or application may no longer interoperate with the operating system. The fact that a device or application may no longer interoperate is annoying for users at a minimum and may prove devastating for devices and operating systems in an industrial context. This is true because devices and applications in an industrial context may be monitoring a critical process. Because an update caused the device or application and the operating system to cease interoperating, the process may move out of tolerance, and leave those operating the system unaware.

Further, the typical state-of-the-art code may require that larger than necessary messages must be passed between a device or application and another device or application external to, or on the same device as the application. The larger the amount of data that must be passed in messages, the more processor power is used, the more network or bus resources are consumed, and the more power is consumed to operate the device or system in order to pass the excess data. Further, with large data packages, there is more chance that the data is corrupted in the transmission. It is more desirable to send compact messages for minimal use of power, and processor and network resources.

For the foregoing reasons, there is a need for a software protocol which maximizes efficiency for adding devices or applications to a device or system and more easily achieving interoperability.

Also, passwords are commonly used in security automation. Passwords may be used to allow access to encrypted files, and access to webpages, and accounts for particular webpages. For example, account information, including personally identifiable information (PII) and financial information such as credit card numbers. Such information may be stored in a secure file, which may only be accessed by entering a correct password. Thus, security levels are increased through the use of passwords.

However, passwords are often terms, such as words, names, and dates that are easily remembered by a user. This fact makes passwords easier to guess for criminals wishing to obtain the information protected by the passwords. Rather than having to use “brute force” methods, that is, try every possible combination to ensure finding the password, the criminals can start with such terms and obtain the password with much less effort.

Many websites and programs now include minimum requirements for passwords. These minimum requirements may include that the password must contain a minimum number of characters. The requirements often include that passwords include a mix of alphabetical characters and numerical digits. In some cases, a user is required to include at least one special character in the password. Of course, each of these requirements, as to total number of characters, the type of character, either alphabetical or numeric, and the special characters, which are neither alphabetical or numeric, increase the complexity of the password, which makes the password more difficult to guess for hackers and criminals. Instead, these criminals and hackers would have to use brute force techniques to obtain passwords, which requires enough effort to often make doing so impractical. This is good for the security of the password, and, by extension, the user.

However, all the increased complexity makes it harder for a user to remember the password, because it divorces the password from everyday use. This complexity can be compounded by a further requirement. Particularly, in at least some instances, there exists a requirement for the user to change their password after the passage of a predetermined time period. For example, a user may be forced to change their password after a predetermined period of time. This means that every six months the user must change their password. In some instances, requirements exist specifying exactly how much the password must change. Sometimes, these requirements are as extensive as those for initial creation of the password. The result is that the user has a difficult time remembering passwords. Multiple complex, changing passwords are inherently difficult to remember, especially those that are used less frequently. For the foregoing reasons, there is a need for a dynamic password cipher which will allow a user to create multiple passwords from a single password.

Theft of intellectual property is a growing area of concern. A more mobile work force means that employees may move between competitors more regularly than in the past. When the employee changes employment, the employees may either unknowingly or knowingly take intellectual property belonging to the company with them to a competitor. Such misappropriation of intellectual property is often the result of files removed from a local machine or a server, or the removal of an entire computer system, for example, a laptop. In some cases, the competitor may even be an extra-territorial competitor who believes that the use of the intellectual property will not be pursued because of the difficulty caused by having to pursue claims in another country or jurisdiction.

Computer files are more easily opened and used worldwide than ever before. If the misappropriation of files is accomplished by taking the hardware, for example, a laptop computer, then the applications which open the files are nearly essentially guaranteed to be present. However, many files are formatted to open on standard applications, regardless of the machine. For example, files formatted for the Microsoft® Office® suite of applications may be opened in Office® applications regardless of the computer and the operating system. If the file is a not as-yet complete set of computer code being drafted by a software engineer, it may be opened by any compiler for the language in which it is being coded. Moreover, if someone is preparing for such a misappropriation of files, files may also be saved in formats which allow them to be opened in a variety of applications on a variety of operating systems. For example, a .txt format file can be opened on nearly any machine worldwide.

The remedies for misappropriation of files are few. Often, the remedy involves a protracted legal battle. Some contemporary measures are available to prevent a misappropriation of proprietary information, to include computer files, but these measures are expensive and cumbersome. Companies would likely prefer to prevent the loss of files, which very well might contain trade secret, or at a minimum, proprietary information, as a lower cost solution than to deal with the consequences of misappropriation. Prevention of the loss of files is much less expensive than a protracted legal battle. Such legal battles may be lost even before they're begun. That is, if the trade secret becomes public, a company cannot put the genie back in to the bottle. No matter how well the litigation goes, the trade secret is lost. Even if the company can get an injunction against the competitor's use and money damages, the long-term harm done to the company by the disclosure of the trade secret may be greater than, and therefore cannot be fully cured by, the injunction and damages.

For the foregoing reasons, there is a need for a local file security system that will prevent the removal of files or computing systems and the use of the file or computing system outside of the owning company.

In the state-of-the-art in wireless communications, signals are encoded by various encoding schemes. The most simple may be binary phase shift keying (BPSK). BPSK is capable of encoding one bit per cycle of whatever frequency signal is being encoded. Two positions of phase shift are used, one to indicate a binary one, and another to indicate a binary zero.

A step up from BPSK is quadrature phase shift keying (QPSK). In QPSK, one symbol per cycle is encoded. That symbol encodes two bits of information, doubling the maximum possible data rate of BPSK. Again, QPSK uses phase shift keying, or changes in the phase of individual cycles, to encode data. Each cycle is independent from the others.

The next step up from QPSK is known as 8PSK. In this scheme, there are eight different phase positions to which the signal may be shifted. By having eight different possibilities, three bits may be encoded by each symbol. One symbol is encoded per cycle.

There are encoding schemes which may provide even more bits per symbol. Quadrature amplitude modulation (QAM) comes in several different formats, from 16 possible points to 256 possible points. 16QAM can encode four bits per symbol, 32QAM can encode five bits per symbol, 64QAM can encode six bits per symbol, 128QAM can encode seven bits per symbol, and 256QAM can encode 8 bits per symbol. Unlike pure PSK, in QAM, both the amplitude and the phase are modulated to encode the symbol.

Each of the encoding schemes may be used in a multi-frequency waveform, for example, orthogonal frequency division multiplexing (OFDM). In OFDM, a set of frequencies forming a bandwidth are each encoded with one of the above encoding schemes. The orthogonality in the OFDM is formed by choosing frequencies which, when viewed in the frequency domain any neighboring frequency is at zero when the frequency in question is at its max.

Thus, in the past, every independent variable has been used to get higher data rates. Phase shifting has been used to encode data, either amplitude alone or in combination with phase shifting has been used to encode data, and bandwidths have been used to encode more data. Primarily, these are all dependent variables. However, time has not been used to provide either additional data per cycle or to combat noise in order to lessen error correction encoding.

For the foregoing reasons, there is a need for a method and system of high data rate encoding and transmission which takes advantage of time in order to provide high data rates and robustness against noise.

### SUMMARY

A method for sending commands and data between devices is described. The method may include sending, using a first copy of a wired or wireless protocol executed by a first processor on a first device, a message carrying the one or more text language elements, from the first device to a second device. The method may further include providing, on the second device, a text language element application including a library of text language elements. The second device may further include a port for receiving the message, a second copy of the wired or wireless protocol, a second processor, and a second memory. The second device may be adapted to receive the message at the port, and may extract, using the corresponding wired or wireless protocol executed on the second processor, the one or more text language elements from the message. Using the provided text language application executed on the second processor, the second device may match the one or more text language elements to corresponding text language elements in the library of text language elements, and may translate the one or more text language elements to computer code executable on the second device.

Also described is a method for operating devices using text language syntax. The method may include sending, using a first copy of a wired or wireless protocol executed by a first processor on a first device, a message carrying the one or more text language elements, from the first device to a second device. The method may further include providing, on the second device, a text language element module including a library of text language elements. The text language module may be integrated with an operating system according to which the second device operates. The second device may further include a port for receiving the message, a second copy of the wired or wireless protocol, a second processor, and a second memory. The second device may be configured to receive the message at the port, extract, using the corresponding wired or wireless protocol executed on the second processor, the one or more text language elements from the message. The second device may use the provided text language module executed on the second processor to match the one or more text language elements to corresponding text language elements in the library of text language elements, and convert the one or more text language elements to commands to computer code executable on the second device.

Also disclosed is method for sending commands and data within a computing device. The method may include coding a text language application including a text language element library. The text language element library may include one or more text language elements. A text language application may be added to a device. The device may include at least one processor, one or more memories, an operating system stored in the one or more memories, the operating system being executed by the at least one processor. The method may further include adding a user operated application to the device by storing it on the one or more memories. The method may still further include opening and operating the user operated application on the device. When the user operated application is opened and operated, the user operated application may send one or more text language elements to the text language application, which, using the text language application, may convert the text language elements in to code executable on the operating system.

Also, disclosed herein is a method for encoding passwords using a dynamic cipher. The method may include loading a cipher algorithm on to a non-transient memory. The method may further include inputting a total number of characters included in a password to the cipher algorithm. The method may also include inputting whether one or more capital letters are required for inclusion in the password, and if the input indicates capital letters are required for inclusion, how many capital letters are required for inclusion. The method may further include inputting whether one or more numbers are required for inclusion in the password, and if the input indicates numbers are required for inclusion, how many numbers are required for inclusion. The method may further include inputting whether one or more special characters are required for inclusion in the password, and if the input indicates numbers are required for inclusion, inputting the special characters available for inclusion. The method may also include forming the alphabet, digits 0 through 9, and the special characters, if any are input, in to a group of available cipher characters. The method further includes scrolling, automatically, through the group of available cipher characters, each character in the group of available cipher characters available for assignment by keystroke during a predetermined time interval. The method further includes initiating the creations of the cipher by assigning the cipher character available for assignment to a plain text letter by making a keystroke on an input device. The method further includes executing additional keystrokes to assign characters available for assignment to each of the other characters of the password. The method further includes creating a secure file including the cipher.

Further disclosed is a method for encoding passwords using a dynamic cipher. The method may include loading a cipher algorithm on to a non-transient memory. The method may include inputting a total number of characters included in a password to the cipher algorithm. The method may further include inputting character type requirements within the password to the cipher algorithm. The method may further include forming the alphabet, digits 0 through 9, and the special characters, if any are input, in to a group of available cipher characters. The method may further include scrolling, automatically, through the group of available cipher characters, each cipher character in the group of available cipher characters available for assignment by keystroke during a predetermined time interval. The method may further include initiating the creation of the cipher by assigning the cipher character available for assignment to a plain text letter by making a keystroke on an input device attached to a computing device. The method may further include executing additional keystrokes to assign cipher characters available for assignment to each of the other characters of the password. The method may further include creating a secure file including the cipher.

Further disclosed is a method for dynamically creating a second password from a first password. The method may include determining a total number of characters in a password. The method may further include assigning positions to each character in the password. The method may further include determining requirements for the password, including a number of capital letters, a number of digits, and a number of special characters. The method may further include inputting, if any are required, a list of special characters. The method may further include using a random number generator determining a character position for each of the capital letters, digits, and special characters required. The method may further include assigning one of a corresponding capital letter, digit, and special character ruleset to each of the assigned character positions within the password. The method may further include assigning a global ruleset to the each of the unassigned character positions within the password. The method may further include using the letters of the alphabet, digits 0 through 9, and, if required, the input list of special characters to create a set of cipher characters. The method may further include randomizing the set of cipher characters. The method may further include changing the cipher character available for assignment according to the ruleset assigned to each character position through a keystroke by maintaining the availability of each of the cipher characters in the set of cipher characters for a predetermined time period. The method may also include assigning the password by making a keystroke of an input device for each of the character positions in the password, the keystroke assigning one cipher character of the set of cipher characters to the plain text character corresponding to the input device key.

Also, disclosed is a system for local computer file security. The system may include a script attached to an encrypted file on a local computing device. The script may include a first subroutine, a second subroutine, and a third subroutine. The first subroutine may include instructions which determine a first CPUID of the machine on which the file is being opened. The first subroutine may further compare the first CPUID against a second CPUID stored in memory by the script to determine if there is a match. The first subroutine may record the result of the CPUID comparison. The second subroutine may include instructions which may obtain a first set data by interrogating a plurality of locations. The second subroutine may further include comparing the first set of data with a second set of data stored in memory, the second set of data indicating the file is being opened on a virtual machine. The second subroutine may further record the result of the comparison. The third subroutine may include instructions which may place the recorded results of the first and second subroutines in a message. The system may include an encryption routine which may encrypt the message. The system may further include a communication protocol which may send the message. The system may further include a company server including a memory, the company server may be electrically connected to the local computing device without any intervening servers. The company server may include a copy of the communication protocol. The system may further include an executable file which may be stored on the memory. The executable file may include instructions which may decrypt the message and check the results of the first and second subroutines. If the results indicate that the CPUIDs matched, and the file was not being opened on a virtual machine, then the system may perform an intermediate server check. If the results indicated that either the CPUIDs didn't match, or that the file was being opened on a virtual machine or both, then the company server may return a message to the local computer that the file cannot be decrypted. The intermediate server check may include a review of the message to determine if the message includes any artifacts indicating that the message passed through another server before arriving at the company server, and if the message does not include any artifacts, the company server may encrypt a message including data that will decrypt the file, or, if the message is determined to include artifacts indicating the message passed through another server, the company server may return a message indicating that the file cannot be decrypted.

Also disclosed is a method for providing local file security. The method may include determining a first CPUID of a machine opening the file. The method may further include comparing the first CPUID to a second CPUID stored in a script on the file. The method may interrogate a first set of data in a plurality of memory locations on the machine opening the file to find artifacts of a virtual machine. The method may compare the first set of data to a second set of data stored in a memory by the script, the second set of data including artifacts indicative of a virtual machine. The method may place results of the comparison in a message for sending to a company server. The local machine may encrypt the message. The method may include sending the message to the company server, and the company server may decrypt the message on the company server. If the results are a match for the CPUID and not a match for the virtual machine, the company server may check the message header to determine if the message has passed through an outside server before arriving that the company server. If the results are not a match for the CPUID or a match for the virtual machine, or both, the company server may send a message to the local machine causing a message saying the file cannot be decrypted to display. If the message has not passed through an outside server before the company server, the company server may send an encrypted message to the local machine with instructions which decrypts the file.

Also disclosed is a system for maintaining local file security. The system may include a local machine including a first memory and a processor. The system may further include a script attached to a file stored on the memory, the script may include instructions for execution on the processor. The instructions may include a first part of a check which may find a first CPUID of a machine on which the file is being opened and may compare the first CPUID to a second CPUID stored in the script. If the first CPUID matches the second CPUID, then the check is passed and the script may record the result, if the first CPUID does not match the second CPUID, then the check is failed and the script may record that result. A second part of the check may review a plurality of memory locations on the local machine for artifacts indicating the machine is a virtual machine. The script may compare a first set of data found in the plurality of memory locations to a second set of data stored in the script, and may record the result. If any of the first set of data from the plurality of locations matches any of the second set of data then the check is failed and the result may be recorded. If none of the first set of data matches any of the second set of data, then the second part of the check is passed and the result may be recorded. A third part of the check which may determine if either of the first part of the check or the second part of the check was failed. If either or both of the first part of the check and second the second part of the check were failed, then displaying text stating that the file cannot be decrypted. If the first part of the check and the second part of the check are both passed, then the script may encrypt and may send a first message to a company server. The company server may include the information that both the first part of the check and the second part of the check were passed. The company server may include an executable file stored on a second memory, and a processor for executing instructions from the executable file. The instructions may include a first set of instructions which may receive and decrypt the message. The instructions may further include a second set of instructions which may check the message to determine if the message passed through another server before arriving at the company server. The instructions may further include a third set of instructions which, if no indications of the first message passing through another server before arriving at the company server were found, may create an encrypted second message including instructions to decrypt the file, and may cause the encrypted second message to be sent to the local machine. The instructions may include a fourth set of instructions which, if an indication of the first message passing through another server before arriving at the company server is found, then the instructions may cause a third message to be sent to the local machine. The third message may cause text to be displayed stating that the file cannot be decrypted.

In some embodiments, a method for transmitting data using orthogonal frequency domain multiplexing can include identifying a lowest frequency subcarrier in an orthogonal frequency division multiplexing bandwidth that includes 64 subcarriers. The method can include selecting the second, fourth, eighth, sixteenth, thirty-second, and sixty-fourth subcarriers in the orthogonal frequency division multiplexing bandwidth and preparing a set of orthogonal functions for each of the second, fourth, eighth, sixteenth, thirty-second, and sixty-fourth subcarriers. The method can further include encoding, using the sets of orthogonal functions, data on each cycle of the second, fourth, eighth, sixteenth, thirty-second, and sixty-fourth subcarriers with data in a transmission interval. The method can further include transmitting the second, fourth, eighth, sixteenth, thirty-second, and sixty-fourth subcarriers over a transmission interval. The method can include receiving the second, fourth, eighth, sixteenth, thirty-second, and sixty-fourth subcarriers using a bandpass filter and decoding the set of orthogonal functions for each of the second, fourth, eighth, sixteenth, thirty-second, and sixty-fourth subcarriers. The method can further include combining the decoded data to recover the transmitted data.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a flowchart of the method between devices.

FIG. 2 shows a flowchart of the method within a single device.

FIG. 3 shows a schematic of the components of the text language module or text language application.

FIG. 4 shows an example of an extended homophonic substitution cipher.

FIG. 5 shows in index view of the relationship of FIGS. 2a and 2b.

FIG. 5a shows a first portion of a flowchart of a method.

FIG. 5b shows a second portion of a flowchart of a method.

FIG. 6 shows a keyboard with a display which may be used in implementing the method.

FIG. 7 shows a schematic view of a system for local computer file security.

FIG. 8 shows an example method of a security check of a plurality of subroutines.

FIG. 9 shows an example method of receiving a message from the local computing device and decrypting the message using a public and company server private key.

FIG. 10 illustrates a visualization of the subcarriers used by an embodiment of the present disclosure.

FIG. 11 shows an example matrix of combinations of symbols.

FIG. 12 shows a block diagram that illustrates a computer system upon which various embodiments may be implemented.

### DETAILED DESCRIPTION

The detailed description set forth below in connection with the appended drawings is intended as a description of the presently preferred embodiment of system and method to transmit commands and data between an external device or application and a translator application on a computing device using text language protocol, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

### Natural-Language Commands

The use of text language syntax to create text language elements can greatly simplify coding requirements, thereby reducing design time and costs and maintenance costs. In this disclosure, “text language” and “natural language” may be used interchangeably and are understood to mean the same thing. Each text language element makes use of common written language words and phrases to provide syntax for computer commands and data in a logical, repeating format. By way of example and not limitation, $\DISPLAYMESSAGE {text {Lamp Connected} font {Arial} fontsize {10} color {black} background {white}} may be the syntax for a text language element. The text language elements, or natural language elements, remove barriers to communication that are typical when a human communicates with a machine through a computer language. The text language element syntax is much closer to human to human communication, but is executable by a machine.

A text language conversion protocol is required in order to create and send, or receive and process, a text language element. The text language conversion protocol can take the form of a software module or an application, as is discussed in detail below. The text language conversion protocol accomplishes two things simultaneously. First, the text language conversion protocol translates computer executable code in to the syntax of the text language element, or vice versa. Second, the text language conversion protocol either amalgamates the function of the computer code in to the much more compact text language syntax, or performs an expansion of the text language element syntax in to computer executable code.

Because text language elements are not a direct one-for-one translation of a single concept or fundamental line of code from the computer language, but rather an amalgamation of several concepts or many lines of code in the computer language, the text language elements may also be said to modularized computer executable code. Often, modules of computer executable code are meant to provide an effect or achieve some end. Similarly, an effect is often reflected in the name of the text language element, as is the case with the “DISPLAYMESSAGE” example given above.

To achieve the operation of text language elements both across and within devices, the text language conversion protocol must be embodied in a way in which the back end, or the portion of the text language computer protocol interoperating directly with the operating system, is modular. This is because, for each version of the text language conversion protocol, this portion must be at least modified, and potentially removed and replaced entirely, depending on the operating system, computer language, or general operating environment to which the version of the text language conversion protocol is keyed.

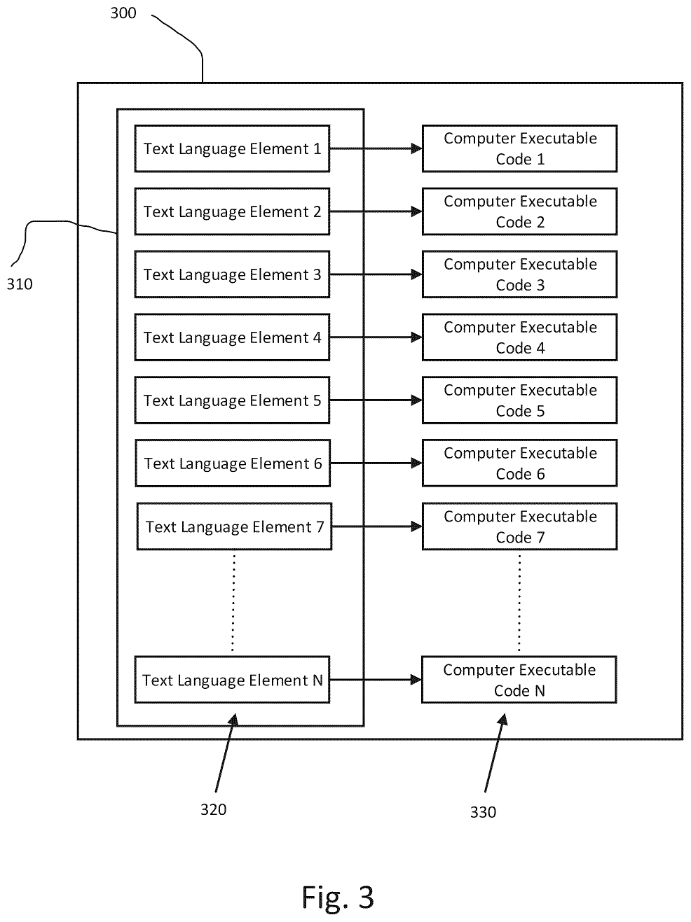

As shown in FIG. 3, the text language conversion protocol 300 may be implemented by either adding a text language module to the operating system itself, or as a separate text language application running in conjunction with, and on, the operating system. Both forms of implementation accomplish the same tasks. That is, at a minimum, they execute the text language conversion. In order to accomplish the conversion, either the module or the application includes a text language element library.

The text language element library 310 is advantageous component of the text language conversion protocol implemented as a text language module or text language application. Individual text language elements 1-N may be aggregated to form a text language element library 310. The text language element library 310 has two parts. The first part is a listing 320 of text language elements 1-N. This listing 320 of text language elements includes every text language element in existence 1 through N. The listing 320 of text language element remains consistent across all versions of the text language modules or text language applications. The second part of the text language element library 310 is computer executable code 330 which corresponds one to one with each of the text language elements 1-N. The computer executable code 330 is keyed to the operating system or computer language on which the text language module or text language application operates. The corresponding computer executable code 330 achieves the intended effect of each of the text language elements. It is this computer executable code 330 which may be removed and replaced as each version of the text language conversion protocol 300 is developed and keyed to a different operating system, computer language, or operating environment.

The text language element library 310 is both fixed and infinitely expandable. That is, the number of text language elements 1-N in the text language element library 310 at any moment in time is fixed at a given number N as shown in FIG. 3. As manufacturers or developers realize new requirements for data or command text language elements during the development of a peripheral device or an application, the corresponding text language element meeting the requirement can be created and added to the text language element library 310, as will be discussed in further detail below. In contrast to a proprietary operating system, the listing of text language elements 320 and their effects are open source, so that peripheral device manufacturers may access the listing of text language elements 320 and understand the capabilities of each of the text language elements and the text language element library 310 as a whole. A peripheral device manufacturer may take any opportunities or limitations in to account before development begins. Moreover, they can seek to close any gaps or address any needs in the text language element library 310 by developing further text language elements to aid in the operation of their device. Development of text language elements is simple compared to development of computer executable code from scratch. The developer or manufacturer may create both the new text language element, and the corresponding computer executable code for at least one operating system, computer language, or operating environment, and submit it to an approval authority. The approval authority may check the computer executable code for adverse effects, and if none are found, add the new text element and corresponding computer executable code to the appropriate version of the text language module or text language application. Based on this original, the approval authority develops computer executable code for other operating systems, computer languages, and operating environments, and publishes updates as required.

Although both may perform the functions of receiving and sending text language elements and performing the conversions as described above, the text language module or text language application on a computing device differs from the text language software on a peripheral device, or in an application on the computing device, in at least two key aspects.

First, the text language software on the peripheral device may be integrated with coding embedded on the peripheral device or application, rather than forming a stand-alone module or application. An application using text language elements has a smaller version of the text language conversion protocol embedded as part of the application's coding, as is next explained. Second, the text language software on the peripheral device or in an application only needs to have in its library the text language elements that the peripheral device or application will be sending or receiving. Typically, these natural language elements relate directly to the operation of the peripheral device or application. Thus, the number of text language elements in the text language software on a peripheral device or in an application may be limited to the functions of the device or application. For example, in the case of a peripheral device, and, specifically, a light, the text language elements may be limited to those for identification of the device, creation of a user interface on the computing device, and binary commands, for example, text language commands which turn a light off and on.

In contrast, the text language element library 310 stored in the text language conversion protocol 300 implemented as the text language module or the text language application on the computing device must include every text language element existing. This is because there is no way to determine, during the installation of the text language element library 310, which peripheral devices or application may be used with the computing device, and the software module or text language application on the computing device must therefore be prepared for each and every text language element known to exist. Further, only the text language module or text language application 300 on the computing device is updated, as described above. However, this is not a drawback, but an advantage.

When the text language module or text language application on the computing device is updated, the text language software on the peripheral device, or in an application on the same computing device, does not need a corresponding update. As discussed above, as new peripheral devices or applications are developed, a need may be generated for new text language elements. These text language elements must be validated and added to the text language library 310 on the computing device's text language module or text language application to allow interoperability with the new peripheral device or application. However, because each text language element is independent, adding new text language elements to the text language library 310 of the computing device text language module or text language application creates no requirement to change the existing text language elements. Thus, the function of existing peripheral devices or applications will be unaffected by the addition of text language elements to the library of the software module or text language application on the computing device.

Contrast this lack of required updates for peripheral devices or applications with the current state of the art, where both the operating system on the computing device and the software on the peripheral device or applications running on the computing device require contemporaneous updates in order to continue to interoperate. Again, the disclosed system allows for lowered costs, both during design and in terms of device maintenance for peripheral manufacturers. Essentially, because of the lack of required updates, there is no cost of device maintenance from a developer or manufacturer standpoint.

The computing device which is connected to the peripheral devices may be a smartphone, a tablet, a laptop, a desktop computer, or any device which runs applications or has an operating system. The computing device may be other devices, but the computing device will include one or more memories, at least one processor, and a display. As discussed above, the text language conversion protocol 300 may be implemented as a software module integrated with the operating system of the computing device. Alternatively, the text language conversion protocol 300 may be implemented as text language application stored and run on the computing device. When the text language conversion protocol 300 is in the form of a text language application, the text language application may be stored in the at least one memory on the computing device. The text language module or text language application may provide functions beyond the sending, receiving, matching, and converting to executable code based on the receipt of text language elements. These functions may be executed on the at least one processor.

The text language module or text language application communicates with other text language modules or text language applications, or embedded coding on peripheral devices or applications that performs text language element conversion. That is, a text language module on a first device or application may communication with a text language application on a second device, or any combination thereof. Alternatively, the text language module or text language application may also communicate with a text language peripheral device conversion protocol, which includes a listing of only those text language elements which are required by the peripheral device or application. In some embodiments, the text language module or text language application stored on the device is the only module/application that communicates with the operating system, computer language, and/or operating environment of the computing device. With the text language element protocol, no external messages communicate directly with the device. Text language elements only communicate indirectly. The text language elements do so through the text language module or text language application, and then only when the incoming text language element finds a match in the text language element library. Thus, the use of text language elements allows for greater security of devices and applications. Not only are potentially harmful incoming messages or code stopped, either because the text language element is not matched in the text language element library or because any malicious code is eliminated by the approval authority before any update, but also the code that operates the device may be maintained as proprietary. When text language elements are used, the coding used to operate the device is irrelevant to the interoperability of the device or application. Interoperability is achieved through the exchange of text language elements. The code that operates the device remains secure behind the text language element module or text language application, which effectively acts as a firewall.

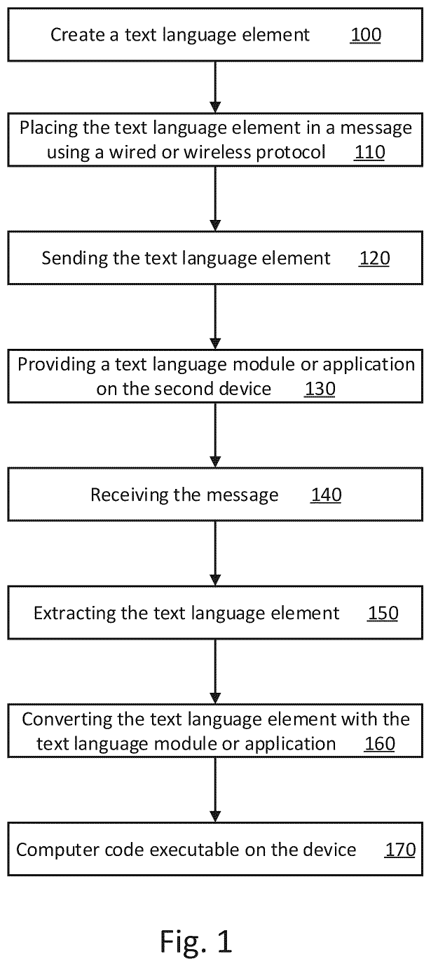

An example of the operation of the text language elements and text language conversion protocol will now be described. This embodiment is understood to be only exemplary to provide an understanding the operation of the text language elements and text language conversion protocol, and is not meant to be limiting. By way of example and not limitation, a first device may send a text language element to direct a second device to display a message on a display of the second device. The message may say “lamp connected.” As shown in FIG. 1, in Step 100, based on code running on the first device, the text language module or text language application may generate or create the text language element: $\DISPLAYMESSAGE {\text {Lamp Connected} font {Arial} fontsize {10} color {black} background {white}}. This text language element includes both command and data components. Specifically, the overall text language element is a command, specifically “DISPLAYMESSAGE.” Then, the text language element includes a number of data sub-components which provide parameters regarding the message to be displayed. These are data elements. The text of the message is specified as “Lamp Connected.” The font and font size for the text “Lamp Connected” are specified as “Arial” and “10.” Finally, the color of the lettering “black” and the color of the background bubble “white” are specified. It is to be understood that such a text language element could depart from the exact format above without departing from the spirit of the disclosure. The exact syntax does not lie at the heart of the disclosure, rather, it is the use of natural or text language to identify each of the elements and the sub components of the elements. For example, instead of braces, parentheses may be used. Alternatively, or in addition, there may be more or fewer symbols placed first in the syntax, before the main identifier of the text language element.

Alternatively, less customization could be allowed for the text language element “DISPLAYMESSAGE.” Black text and white background may be mandated with only font and font size being customizable aspects of the chosen text. Thus, the text language element would be altered to “$\DISPLAYMESSAGE {text {Lamp Connected} font {Arial} fontsize {10}}.” The elements can use descriptive text in each of the text language elements, for the name of the element itself and/or for the components of the element.

As the text language element conversion protocol does not include an integrated protocol for transmission, in Step 110 text language elements may be packaged in a wired or wireless protocol and sent externally in the wired or wireless protocol as data. The process of packaging data in a wired or wireless protocol for sending on a network is well known in the art. The first device sends packets with the text language elements in the data portion of the wireless or wired protocol to the second device. The second device may send an acknowledgement to the first device that the message was received. Most wired or wireless protocols include bilateral communication, so the first device also receives signals sent from the second device. It is understood that one device may receive from or send signals or messages to, more than one device. The signals or messages may be sent via wired or wireless connections. In addition, in one embodiment, the first device may send the signals directly to the second device. In other embodiments, the signal may pass through one or more intermediate devices. These intermediate devices may include devices incorporating a router. These intermediate devices may only be a router, or may perform functions beyond those of a router, while still incorporating router functions. For example, an intermediate device may perform both device management and router functions.

Wireless protocols may include Bluetooth or WIFI connections using a TCP/IP protocol, and the wired protocols may include a local area network of ethernet cable using TCP/IP or other protocols, for example universal powerline bus over structural electrical wiring, or similar powerline communication protocols.

In Step 130, the second device has a text language conversion protocol implemented on it, in the form of a text language module or text language application. As shown in Step 140, the second device, using the the wired or wireless protocol, receives the message. The wired or wireless protocol then, as in shown in Step 150, extracts the text language element and delivers the data within the device. By way of example and not limitation, the TCP protocol may deliver the data contained within a message, in this case, the text language element “DISPLAY MESSAGE” to the text language module or text language application on the second device. In Step 160, the text language module or text language application on the second device receives the text language element “DISPLAY MESSAGE,” and, using the library, attempts to find a match. If a match is found, the text language module or text language application determines the computer executable code corresponding to the text language element “DISPLAY MESSAGE.” If no match is found, then nothing may occur.

As shown in Step 170, once a match is found, the text language element is converted in to computer executable code. Depending on the operating system, computing language in use, or the computing environment, the computer executable code may take any number of forms. However, the effect of the computer executable code remains consistent. A message saying “Lamp Connected” in black Arial 10-point font inside a white dialog bubble is displayed on the display of the computing device for some period of time. The period of time may be specified in the executable code based on the parameter of the “DISPLAYMESSAGE” text language element. Alternatively, the length of time the message is displayed may be a user specifiable parameter in the text language element.

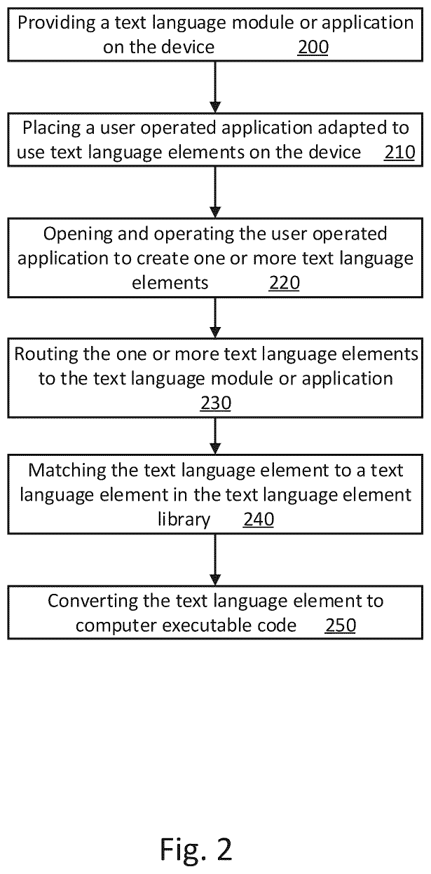

As shown in FIG. 2, just as text language elements may be used to send commands and data between devices, as in the embodiment above, text language elements may also be used to send commands and data within a single device. Specifically, the text language elements may be used by an application running on the device, as shown in Step 210. Of course, in order for the text language elements to be converted in to computer executable code, a text language conversion protocol must be implemented in the form of a text language module or a text language application on the device, as shown in Step 200. When used within a single device, the application on the device may opened and operated to generate one or more text language elements, as is shown in Step 220. These generated one or more text language elements, which may include commands, or data, or both, can be routed external of the application and within the device to the the text language module or text language application, as shown in Step 230. The operation of the text language module or text language application is the same as described above. That is, in part, after matching a text language element to one in the text language element library, the text language element is converted in to the corresponding computer executable code, as is shown in Steps 240 and 250, respectively. Essentially, the text language elements may be used as a coding shortcut because of their amalgamation of more basic computer code through the conversion in to text language element syntax. Again, because of the compact nature of the text language syntax, the coding required for the application may be greatly reduced, allowing faster development of applications.

Developers of applications which use text language elements can be assured that such functions will have their intended effect across operating systems and in operation with code in any of a number of computer languages. Thus, not only may a first product for use on a first operating system be quickly developed, but it is possible with the use of text language elements that the first product will function across a number of operating systems. Thus, when using text language elements to code application there is no need to port the code from operating system to operating system. In the state of the art, an application may come out compatible with a single operating system. Consumers regularly using operating systems other than that for which an application was initially developed are forced to wait for a version of the application compatible with that different operating system to be developed. Sometimes, it is never developed. With the use of text language elements, the same version of an application will work across operating systems.

The text language elements provide a truncated learning curve due to their close relationship to their spoken or written word counterparts, and because there is no need to learn fundamental concepts which only relate to the operation of computers. Instead, a user may begin by using text language elements almost immediately. Even a non-software engineer can become comfortable with the protocol in a limited period of time. This means that the development process for device manufacturers and application coders is similarly truncated. This allows at least some developers or manufacturers who could not previously afford the expensive and tedious traditional development process, including drafting thousands upon thousands of lines of computer code, which may or may not function properly when completed, to enter the market.

The text or natural language elements may be directed to commands or data, or both. As noted above, the syntax of each of the text or natural language elements is largely composed of words used in the manner they would typically be used in the written language from which they are derived.

By way of example and not limitation, a second example will be discussed which clearly illustrates the ability of text language elements to accomplish commands with the use of data, or to send solely either a command or data. The text language module or text language application may facilitate the near real-time creation of a custom user interface, which allows a user to control the devices connected to the computing device. The creation of the user interface is done using text language elements as well.

The following text language elements may be used in the creation of a user interface. The text language element “$\BACKCOLOR {color {royalblue}}” may be sent to establish a background color for a screen of the user interface. In this case, the background, or wallpaper, color would be royal blue. The text language element “$\RADIOBUTTON {labeltext {On/Off} size {12} font {Arial} fontcolor {white} location {20,40}}” may be sent to create a radio button on the screen. The radio button may have the text “On/Off” in size 12 Arial font in the color white. The radio button would be located at the location 20, 40 on the screen.

The user interface described above may allow the user to control one or more features of the connected peripheral device or devices. Such control would be accomplished by providing control surfaces on the user interface. The radio button described above may be one such control surface. The user interface may have one or more control surfaces. The manipulation of the control surfaces either directly or indirectly (through the text language module or text language application) generates text language elements which are sent to either a peripheral device or to the computing device, depending on the function indicated on the user interface. The peripheral device unpackages the data, in this case one or more text language elements, or the computing device receives the text language element, and determines, based on the text language elements, the corresponding computer executable code as described above. In the case of the creation of a user interface, there may be both command text language elements and data text language elements. The command text language elements may include data sub-components.

Once the user interface is established, a user may exercise control over the peripheral device via the control surfaces provided on the screen for the peripheral device in the user interface. A user may manipulate these control surfaces on the computing device. For example, in the case of a radio button, the user may choose to toggle the state of the device from off to on. This manipulation by the user in turn generates a command in the operational protocol of the computing device that is passed to the text language module or text language application on the computing device for conversion in to a text language element. For example, the text language element might be “$\LIGHTON {state {1}}” or “$\LIGHTOFF {state {0}}.” The text language element is then sent to the peripheral device where the text language element is converted in to code executable on the peripheral device, and the light is turned on or off.

In some embodiments, text language elements can be used even more fundamentally, specifically, as a programming language unto themselves. As with the exemplary embodiments discussed above, the use of text language elements allows for a much shorter learning curve. Because applications unto themselves do not require hardware design, such applications may be coded using far fewer resources than comparable applications programmed using state-of-the-art. Each element of the text language element is intuitive, and given the breadth of the library, many commands may be used and data may be passed, allowing many common functions to be performed. Gaps may be covered either by adding text language elements to the library or by coding in known computer languages for bridge the gaps. The individual facts and circumstances may dictate one choice or the other.

### Dynamic Password Cipher

The detailed description set forth below in connection with the appended drawings is intended as a description of the presently preferred embodiment of a system and method to provide security for payment cards, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

Because of the massive amount of hacking and online fraud, many websites and computer systems require passwords. Moreover, many require complex passwords, including large sets of characters, which often include letters, capital letters, numbers, and special characters. The method disclosed herein allows a user to enter the same password, but have that password filtered by a dynamic cipher. The dynamic cipher generates multiple passwords from the single password. Further, the rules for the cipher may be modified to meet any system's requirements.

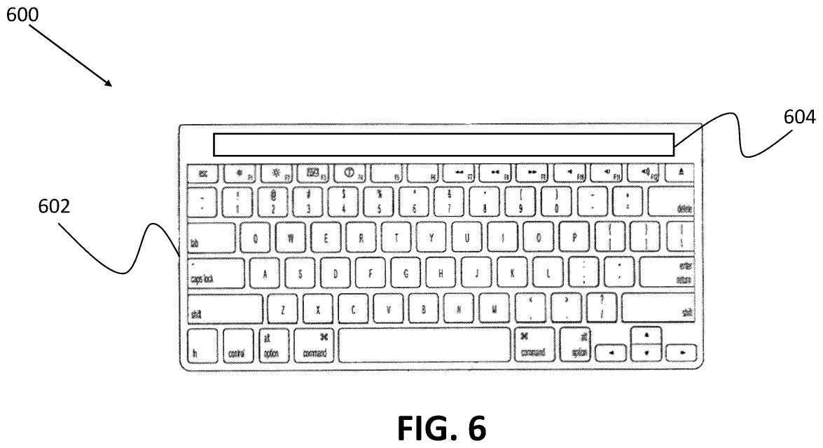

The method can be implemented either using software alone, or a combination of hardware and software. As shown in FIG. 6, a keyboard 600 either includes a dynamic extended mixed alphabet cipher using homophonic substitution or is linked to a software application which includes a dynamic extended mixed alphabet cipher. When implemented as hardware, the keyboard may have a housing 602, a memory (not shown), a processor (not shown), and a display 604. The cipher algorithm may be stored in the memory, and execute on the processor. The keyboard may have a hardware button to activate the cipher function. When the button is pressed, the cipher algorithm activates a software switch which prevents the keyboard from inputting to the computing device to which it is attached. The input instead goes to the cipher algorithm running on the keyboard itself, with prompts displayed on a display integral with the keyboard.

The cipher included in the cipher algorithm is an extended mixed alphabet cipher. An extended mixed alphabet cipher using homophonic substitution is a cipher that may assign one or more letters, digits, or special characters to each of the letters of the alphabet to encode information, in this case a password. More letters are assigned to more frequently used characters to make an attempt to break the cipher using frequency analysis more difficult.

Before any encoding, some preliminary parameters may be input in to the cipher algorithm. For example, if the password is required to be a certain number of characters, that value may be input to the cipher algorithm through an input device, as just one example, a keyboard, as is described in detail below. Alternatively, if the user is already aware of the password the user wishes to use, then the user may count the number of letters in the intended password and input that number. For example, often times there is a requirement that a password contain at least a certain number of characters. The user's intended password may contain more than that number of characters. The user may have the additional characters because that combination is easier to remember while still meeting the requirement that the password be at least a certain number of characters. The information regarding the number of characters in the password will make it easier to assign all the characters used in the cipher, as is described in detail below.

Additionally, the user may enter other parameters for the cipher which are driven by password requirements. For example, the file for which the user is creating the password may require that the password contain a certain number of different types of characters, as well as an overall number of characters. These requirements with direct the cipher so that it meets the password requirements automatically, thus leaving the user free to key in a natural language word or phrase as a password.

Initially, the cipher is not set. That is, none of the characters are assigned to letters of the alphabet. Rather, all of the available characters are cycling through an availability protocol, which is part of the cipher algorithm. Each character may be available for capture for a fraction of a second. When the user makes a keystroke, the character available for capture is assigned to the password. By way of example and not limitation, each character may be available for a tenth of a second. When the user makes a keystroke, at contact of the key, the current character is captured for inclusion in the code. Depending on the character, as is explained in further detail below, this may be the only character assigned to that letter, or may be one of a plurality of characters assigned to that letter. Once the first character is assigned, the remaining characters continue to cycle through availability, awaiting the next key stroke.

The user makes the next keystroke, and again, the next on cycle character is assigned to that letter. This method of assignment continues until the entirety of the password has been typed.

More specifically, if the user has input requirements that the password contain a specific number of required characters, the cipher algorithm may prompt the user to enter the total number of characters in the password. In preparation for additional parameters, the cipher algorithm may also create and number character positions for each character in the password, For example, if a password has N characters, the first character is position one, the next character is position two and so on until position N is reached.

The cipher algorithm may include a ruleset for each of the types of required characters. For example, there may be a requirement that a password contain at least one capital letter. Thus, the cipher algorithm may assign a capital letter to the first character position of the password. The cipher may include both the capital and lower case letters assigned to a single input letter. For example, if the first letter input by the user is an “s,” and the cipher is cycling through the letter “i” when the keystroke is made, then the cipher may assign a “I” as the first letter of the password, and also assign “i” for subsequent use. If “e” is the next letter typed by the user, and “p” is cycling through as the keystroke is made, the cipher may assign “p” as the second character of the password, and “P” is also assigned for potential subsequent use. Thus, if a letter is assigned as one of the characters of the password, both the capital and lower case versions of the letter are assigned, and both point to back to the same letter entered by the user. Alternatively, the capital letters may be assigned apart from the lower case. For example, the capital “I” may be assigned to a plain text “s” by keystroke, and a lowercase “i” assigned to the plain text letter “w” by keystroke.

The password may also require numerical digits be included in the password. For example, a system may require that two numerical digits be included in the password. When the user enters this parameter, the cipher algorithm uses a random number generator to determine which of the characters will be numeric characters. For example, if there are eight total characters, the random number generator may determine that the third and seventh characters will be numeric characters. When the user goes to enter the third character of the password, the algorithm checks if any numeric characters have already been randomly assigned. If not, then the cipher cycles through all of the digits 0-9. If one has been used, then the cipher cycles through all of the remaining numeric digits. When the user makes a keystroke, a numeric digit is assigned to character three. The cipher then moves to character four, cycling through all the remaining characters, alphabetical, numerical, and special until a keystroke is made, and a character chosen. The same for characters five and six. When the cipher reaches character seven, again the cipher algorithm cycles only the remaining numeric characters until a keystroke is made, and a numeric character assigned.

If special characters are required as part of the password, the information regarding their requirements may also be input before the password is created. There may be a required number of special characters in the password. There may also be only certain special characters allowed. For example, “$” may be an allowed special character, but “*” may be disallowed. In the case that the special characters are restricted to certain ones of the special characters, the cipher algorithm would require the user to input the special characters which are allowed. Using the input information, the cipher algorithm may include the special characters in the possible characters for each of the characters in the passcode, and, using a random number generator, may determine which characters in the password will be special characters. For example, if the password is 10 characters, the random number generator may determine that characters positions four and seven are to be the character positions reserved for the special characters.

The procedure for determining the special characters is similar to that of determining the numbers in the password. That is, the special characters may be included in the scrolling list of possible characters for any non-assigned character slot, and potentially assigned when the user presses a key. When the assigned special character positions are reached, the algorithm determines if a special character has been assigned in one of those positions and removes that special character from the list of available special characters. If a special character is assigned in a non-assigned position, the cipher algorithm may simply assign different special characters in the assigned special character positions. Alternatively, the cipher algorithm may have instructions that for each special character which is assigned in a global position, one of the assigned special character positions is converted to a global position. Thus, if no special characters have been assigned in the first, second or third global positions in the example above, the cipher algorithm moves to the fourth character position, and the scrolling list of possible characters is reduced to only the special characters. When the user presses a key, the special character currently available on the scrolling list is assigned. The cipher algorithm then moves to the fifth character position. The fifth character position is a global position, and all unused special characters are included with all other the other unused characters in determining the character assigned to the fifth character position. The same for the sixth character position. If any special characters need to be assigned when the cipher algorithm gets to the seventh character position, the cipher algorithm may again reduce the list of available characters to the remaining special characters. When the user makes a keystroke, a special character is selected from the scrolling list. With the special character requirement filled, the cipher algorithm moves to the eighth character position, which is a global character position.

Once the user has completed entering all of the characters of the password, the remaining characters may be assigned according to a modified homophonic substitution. The homophonic substitution is modified by extending it to include the specified special characters. As in a typical homophonic substitution, the numerical digits may be assigned along with the letters of the alphabet. The special characters may also be assigned to letters to make frequency analysis less effective in cipher cracking attempts.

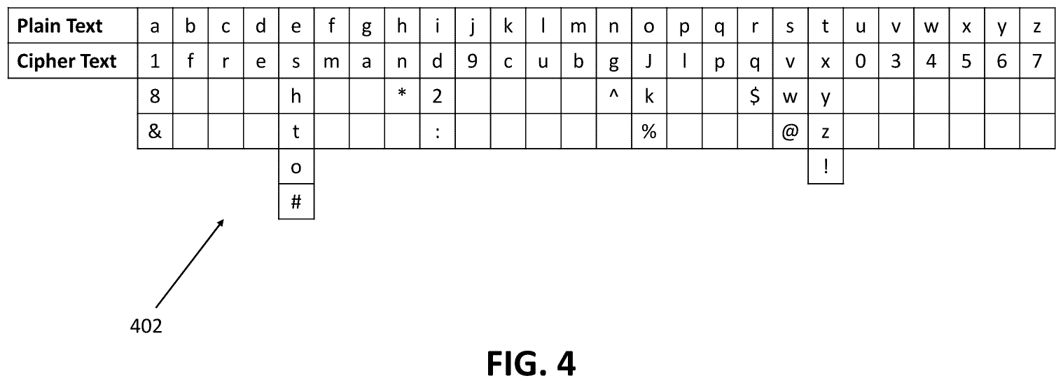

As shown in FIG. 4, a homophonic substitution 402 of this disclosure uses the digits 0-9 in addition to the letters of the alphabet. Because this is more than 26 characters total, the homophonic substitution in a mixed alphabet cipher assigns two characters to the letter “a,” four characters to the letter “e,” two to the letter “i,” two to the letter “n,” two to the letter “o,” two to the letter “s,” and three to the letter “t.” The special characters simply add to the total number of characters which may be assigned to the plain text letters. Because it is not known exactly how many special characters may be included before a user enters them, the cipher algorithm may include a ruleset as to which alphabet letters get assigned either a second, or more, character of the pool of special characters.

The rules for distributing the special characters may establish a priority list for placement of the special characters in the cipher in relation to the letters of the unencoded, or plain text, alphabet. The ruleset may include that if there is at least one special character, then the letter “h” may receive a second character in addition to the single character already assigned. If there are two special characters, the letter “r” may receive a second character in addition to the single character already assigned. The entirety of the priority list for assigning letters may be, in order of priority from highest to lowest, h, r, c, t, a, o, i, n, and s. If there are additional special characters, the priority list may repeat, meaning that additional characters may be assigned, in order, to h, r, e, t, a, o, i, n, and s. If the list has repeated twice, an additional character may be assigned to the letter “d” before additional characters are assigned to the above priority list again. If there are still more special characters, the letter “d” may receive another cipher character, and then the priority list repeated again for additional assignments until all cipher characters are assigned to plain text characters.

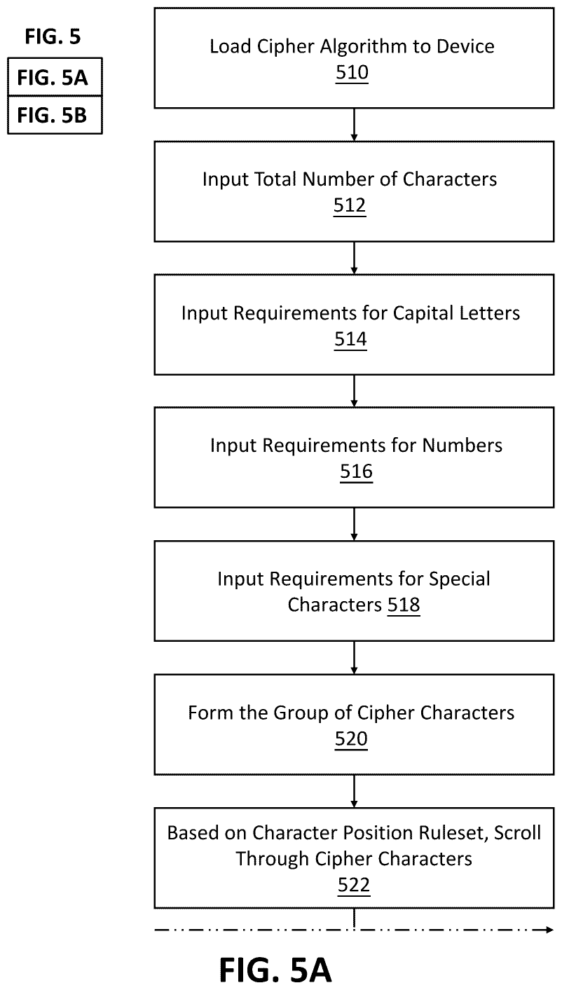

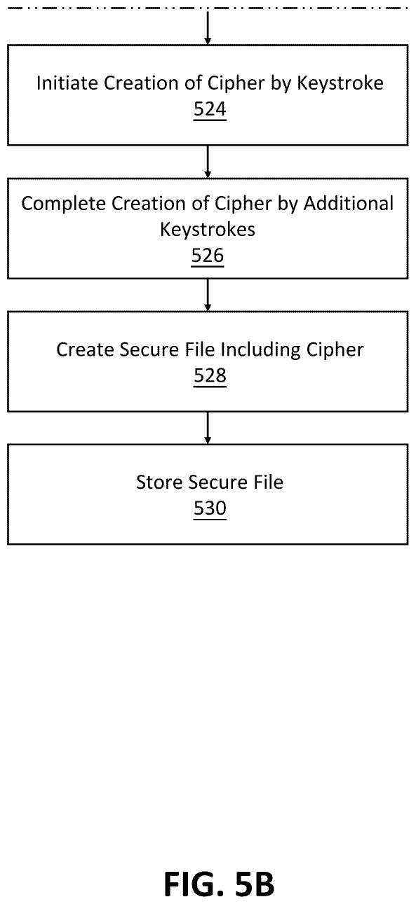

In operation, as shown in Step 510 of FIG. 5A, the disclosure may be implemented as either a combination of standalone software running on standalone hardware, or software interacting with an input device, for example a hardware keyboard, a virtual keyboard, text input with a stylus, text input with a light pen, or any other method of text input, or a combination of hardware with integral software and software running on a computing device. For example, in the combination, the software may be divided between the keyboard and on the computing device to which the keyboard is attached. The computing device may be a desktop or laptop computer, a tablet, a smart phone, or any other device which requires password input and accepts that input from either a virtual or physical keyboard, or other hardware input device. The cipher algorithm may be uploaded during or after manufacture of the hardware.

A cipher creation cycle may begin after a local file or website requests that a password be created. Based on the request for creation of a password, the cipher algorithm initiates with the cipher algorithm requesting certain input. This request may be made by the software, either in a window open on a computer screen or on a display built in to the keyboard. As shown in Step 512, the first prompt or request from the cipher algorithm may be for the user to enter how many characters are in the password. For at least some passwords, the only password requirement is that the password contain at least a certain number of characters. In order to properly create a password and the associated cipher, the user must choose a plain text password which meets or exceeds this required number of characters. The plain text password being the password that the user enters by entering text, for example by making a keystroke. Although keystroke is used here because it is the most common method of text entry, it is understood that a keystroke may refer to any method of entering a single character of plain text. The plain text password may be more than a single word. The words may be combined without spaces, or, if allowed, a special character, for example, an underscore, may be used to separate the plain text words. The plain text password may include any letter. The plain text password may be more than one word, and may not follow the rules of conventional grammar, for example, capitalization, or hyphenation.

The user would first choose a password that fits the length of characters requirement and count the number of characters so that number could be input as a parameter for the cipher algorithm. By way of example and not limitation, there may be an eight character requirement, and the user chooses a password with 10 characters. The user enters the number “10” in answer to the prompt from the cipher algorithm. All 10 characters begin as global characters. That is, all 10 characters may be assigned any of a letter, a number, or a special character. Some of these global characters may change status, and become assigned characters, meaning that they may only be one type of character, as is further described below.

The cipher algorithm, as shown in Step 514, through the same or another window, or on the display on the keyboard, may then prompt the user if there is a requirement that the password include capital letters. The user may enter either a “yes” or “no” answer in the form of a corresponding “y” or “n” keystroke. Next, the cipher algorithm may prompt the user to enter how many capital letters are required. This prompt is delivered in the same manner as the other prompts in this example. The user would then enter a number value. Continuing with the previous example, the user may understand that the password is required to have one capital letter. Correspondingly, the user may enter “y” to the first prompt, and “1” to the second.

The cipher algorithm, based on the input of “y” and “1” may then run a random number generator to produce a number between 1 and 10. For example, the random number generator may output the number nine. The algorithm takes this result and tags the ninth character in the password as being an assigned character, having a requirement to be a capital letter. Alternatively, the cipher algorithm may prompt the user, asking if the user wishes to choose which character will be the capital letter. Further, the prompt may allow a response that the user does not wish to specify which character, and the algorithm then proceeds as described above with running the random number generator.

As shown in Step 516, the cipher algorithm may next prompt the user if there are any numbers required in the password. The user may again enter either a “yes” or “no” answer in the form of a corresponding “y” or “n” keystroke. Next, if the user indicated in the positive that the password required numbers, the cipher algorithm may prompt the user to enter how many numbers are required. This prompt is delivered in the same manner as the other prompts in this example. The user may then enter a number value indicating how many numbers are required to be in the password. For example, the user may enter “2,” indicating that the password requires two numbers.

Continuing with the example, the cipher algorithm, based on the input of “y” and “2” then runs a random number generator twice in order to produce two numbers between 1 and 10. If the result is nine, then the random number generator is run as many additional times as required to produce two results, neither of which is a nine, because the ninth character position has already been assigned as a capital letter. For example, the random number generator may output the number five, corresponding to the fifth character position. Next, the random number generator may output the number nine, corresponding to the ninth character position. The cipher algorithm ignores this result and runs the random number generator again. This time the random number generator outputs a two, corresponding to the second character position. The algorithm takes this pair of results and tags the second and fifth character positions in the password as being assigned character positions, specifically, having an assigned ruleset, in this case a number ruleset. The tagging by the cipher algorithm attaches a ruleset to that character that causes a reduced set of characters to scroll for that keystroke. Specifically, for the second and fifth characters only numbers will scroll, excluding numbers previously assigned to either global character slots or other assigned character slots. Alternatively, the cipher algorithm may prompt the user if the user wishes to choose which characters will be the numbers. Further, the prompt may allow a response that the user does not wish to specify which characters will be numbers, and the algorithm then proceeds as described above with running the random number generator.

As shown in Step 518, the cipher algorithm may next prompt the user about whether the password requires any special characters. As with all of the other prompts, this prompt may be in the form of a question either on a software window displayed on a computer display, or on a display integral with the keyboard. The user may again enter either a “yes” or “no” answer in the form of a corresponding “y” or “n” keystroke. Alternatively, for this response or any of the others, the software version may include radio buttons which may be clicked. Next, if the user indicated in the positive that the password required special characters, the cipher algorithm may prompt the user to enter how many special characters are required. This prompt is delivered in the same manner as the other prompts in this example. The user may then enter a number value indicating how many special characters are required to be in the password. For example, the user may enter “2,” indicating that the password requires two special characters.

The cipher algorithm may further prompt a user to enter the available special characters. Many password systems exclude some special characters on the keyboard, limiting the available special characters to a specified group. Alternatively, there may be no restricted special characters, and the user may enter as many as they wish, but the user is not required to list any. Thus, the user may choose the group of special characters, and limit the group to less than all the available special characters if the user wishes.

Once the user has input the group of available special characters, the cipher algorithm may distribute the special characters in the cipher by assigning the special characters to represent one of the letters of the unencoded, or plain text, alphabet. The rules for distributing the special characters may establish a priority list for placement of the special characters in the cipher in relation to the letters of the unencoded, or plain text, alphabet. The ruleset may include that if there is at least one special character, then the letter “h” may receive a second character in addition to the single character already assigned. If there are two special characters, the letter “r” may receive a second character in addition to the single character already assigned. The entirety of the priority list for assigning letters may be, in order of priority from highest to lowest, h, r, e, t, a, o, i, n, and s. If there are additional special characters, the priority list may repeat, meaning that additional characters may be assigned, in order, to h, r, c, t, a, o, i, n, and s. If the list has repeated twice, an additional character may be assigned to the letter “d” before additional characters are assigned to the above priority list again. If there are still more special characters, the letter “d” may receive another cipher character, and then the priority list repeated again for additional assignments until all cipher characters are assigned to plain text characters. The special characters may be taken from the entered group in the order in which they were entered by the user when prompted.

Continuing with the example, the cipher algorithm, based on the input of “y” and “2” then runs a random number generator twice in order to produce two numbers between 1 and 10. If the result is two, five, or nine, then the random number generator is run as many additional times as required to produce two results, neither of which is a two, five, or nine. Two, five, and nine must be excluded because the second and fifth characters are already assigned number characters, and the ninth character is already an assigned capital letter character. For example, the random number generator may output the number six. Next, the random number generator may output the number nine. The cipher algorithm ignores this result and runs the random number generator again. This time the random number generator outputs a two. Then random number generator also ignores this result and runs again. The random number generator then outputs a three, corresponding to the third character position. The algorithm takes this pair of results and tags the third and sixth character positions in the password as being assigned character positions, specifically, having a requirement to be one of the input special characters. The tagging by the cipher algorithm attaches a ruleset to that character position that causes a reduced set of characters to scroll for that character position. Specifically, for the third and sixth characters only the input special characters will scroll, excluding any special characters previously assigned to either global character slots or other assigned character slots. Alternatively, the cipher algorithm may prompt the user if the user wishes to choose which characters will be assigned as special characters. Further, the prompt may allow a response that the user does not wish to specify which characters will be numbers, and the algorithm then proceeds as described above with running the random number generator.

Once all of the above has been input, as shown in Step 520, the group or list of available cipher characters is set through the input, and the cipher algorithm prompts the user to begin entering the password. Almost immediately, as shown in Step 522, the cipher algorithm begins cycling through all of the available characters for the first character position. The available characters depend on whether the first character position has been designated a global character position, or an assigned position. Global character positions may be assigned any character not already assigned. Assigned positions are subject to one of a plurality of rulesets which limit that character position to a type of character. The type of character for an assigned character position may be a capital letter, a number, or a special character, for example.

Continuing with the above example, the first character of the ten character positions is a global character position. Therefore, all of the letters of the alphabet, any of the digits, and any of the group of input special characters, if any special characters were input, are available for assignment via keystroke. All of the above are scrolling through at whatever time interval has been chosen. For example, each character may be available for a tenth of a second. Alternatively, availability of characters for less than a tenth of a second and more than a tenth of a second are contemplated. As shown in Step 524, when the user makes the keystroke, the currently available cipher character is selected, and added to the password in character position one. Further, the cipher character in position one in the password is keyed to the typed plain text, or unencoded, letter as the first step in creating the cipher.

As shown in Step 526, the cipher algorithm then moves to the second character position. Continuing with the same example, the second character position is an assigned position. Specifically, the second character position is assigned as a number character. Therefore, the cipher algorithm follows a ruleset which requires that only the numbers not previous assigned are randomized and each made available, in order, for a limited time period. As above, each may be available for a tenth of a second. Time periods of less than a second and more than a second are also contemplated. This process of making the characters available for a limited time period, in order, may herein be called scrolling. Just as with the letters of the alphabet, the assignable characters do not scroll in order, that is, a-z and 0-9. Rather, the letter and number order is randomized by the cipher algorithm before scrolling begins. Thus, if a number was not selected in position one, then all of the randomized digits scroll before the user makes a keystroke. If a number was selected in position one, then that number is excluded from the scrolling numbers in position two. Alternatively, if a number was chosen in character position one of the password, the assignment of character position two may be removed, and instead become a global character position. Once the user makes a keystroke, a number may be assigned to character position two of the password. The number, as a cipher character, may be further associated with the plain text, or unencoded, letter typed by the user to further establish the cipher.

The cipher algorithm then moves to the third character position. Continuing with the example, the third character position is an assigned position. Specifically, the third character position is assigned as a special character position. Therefore, the cipher algorithm follows a ruleset which requires that only the special characters not previous assigned scroll in a randomized set. That is, just as with the letters of the alphabet and the digits, the assignable special characters do not scroll in any order, for example the order in which they were entered when the cipher algorithm prompted the user to do so. Rather, the special character order is randomized by the cipher algorithm before scrolling begins. Thus, if a special character was not selected in position one, then all of the randomized special characters scroll before the user makes a keystroke. If a special character was selected in position one, then that special character is excluded from the scrolling special characters in position three. Alternatively, if a special character was chosen in character position one of the password, the assignment of character position three may be removed, and character position three may instead become a global character position. Once the user makes a keystroke, a special character may be assigned to character position three of the password. The special character may be further associated with the plain text, or unencoded, letter typed by the user to further establish the cipher.

The cipher algorithm next moves on to the fourth character position. The fourth character position is similar to the first character position in that the fourth character position is also a global character position. Thus, the entirety of the randomized letters, numbers, and special characters which have not been assigned to a previous character position are scrolled for the fourth character position. As with the previous character positions, and particularly character position one, the reduced list of randomized characters scrolls, and the user executes a keystroke. The keystroke assigns the currently available cipher character to the plain text typed letter, further generating the cipher.

Once the fourth password character position character is assigned, the cipher algorithm moves on to the fifth password character position. Continuing with the example, the fifth character position is again an assigned position. Specifically, the fifth character position is assigned as a number character. Therefore, the cipher algorithm follows a ruleset which requires that only the numbers not previous assigned scroll randomly. That is, just as with the letters of the alphabet, the assignable characters do not scroll in order, that is, a-z and 0-9. Rather, the letter and number order is randomized by the cipher algorithm before scrolling begins. Thus, any number selected in positions one through four is not included in the randomized digits which scroll prior to the user making a keystroke. If a number was selected in any of positions one through four, then that number is excluded from the scrolling numbers in position five. Of course, it is certain that at least one number was selected in this example, because password character position two was an assigned character position. Alternatively, if a number was chosen in global character positions one or four of the password, the assignment of character position five may be removed, and character position five may instead become a global character position. Once the user makes a keystroke, a number is assigned to character position five of the password. The number is further associated with the plain text, or unencoded, letter typed by the user to further establish the cipher by keying the number to the letter typed by the user on the keyboard.

Once the fifth password character position is assigned, the cipher algorithm then moves to the sixth character position. Continuing with the example, the sixth character position is an assigned position. Specifically, the sixth character position is assigned as a special character position. Therefore, the cipher algorithm follows a ruleset which requires that only the special characters not previous assigned scroll randomly and may be selected for assignment. That is, just as with the third password character position, any special character selected in either of global character positions one or four, or special character assigned position three, then that special character is excluded from the scrolling numbers in position six. Of course, it is certain that at least one special character was selected in this example, because password character position three was an assigned character position. Alternatively, if a special character was chosen in character positions one or four of the password, the assignment of character position six may be removed, and instead character position six may become a global character position. Assuming the sixth character position is not made global, and continuing with the example, the special character order is randomized by the cipher algorithm before scrolling begins. All of the randomized special characters except for the special character assigned to password character position three, and any special characters that may have been assigned in global positions one and four, scroll before the user makes a keystroke. Once the user makes a keystroke, a special character may be assigned to character position six of the password. The special character may be further associated with the plain text, or unencoded, letter typed by the user to further establish the cipher by keying the number to the letter typed by the user on the keyboard.

Once the sixth password character position is assigned, the cipher algorithm then moves to the seventh character position. Continuing with the example, the seventh character position is a global position. Thus, the entirety of the randomized letters, numbers, and special characters which have not been assigned to a previous character position are scrolled for the seventh character position. The reduced list of randomized characters scrolls, and the user executes a keystroke. The keystroke assigns the currently available cipher character to the typed plain text, or unencoded, letter, further generating the cipher.

Once the seventh password character position is assigned, the cipher algorithm then moves to the eighth character position. Continuing with the example, the eighth character position is a global position. Thus, the entirety of the randomized letters, numbers, and special characters which have not been assigned to a previous character position are scrolled for the eighth character position. The reduced list of randomized characters scrolls, and the user executes a keystroke. The keystroke assigns the currently available cipher character to the typed plain text, or unencoded, letter, further generating the cipher.

Once the eighth password character position is assigned, the cipher algorithm then moves to the ninth character position. Continuing with the example, the ninth character position is an assigned character position. Specifically, the ninth character position is a capital letter position. The ruleset for the capital letter position on allows any remaining cipher letters to scroll, and when one of those letters is assigned by keystroke of the user, assigns the capitalized letter to the character position. Thus, the entirety of the randomized letters which have not been assigned to a previous character position are scrolled for the ninth character position. The reduced list of randomized characters scrolls, and the user executes a keystroke. The keystroke assigns the currently available cipher character to the typed plain text, or unencoded, character, further generating the cipher.

Once the ninth password character position is assigned, the cipher algorithm then moves to the tenth character position. Continuing with the example, the tenth character position is a global character position. Thus, the entirety of the randomized letters, numbers, and special characters which have not been assigned to a previous character position may be scrolled for the tenth character position. The reduced list of randomized characters scrolls, and the user executes a keystroke. The keystroke assigns the current cipher character to the typed character, completing the user portion of generating the cipher.

Once all the characters of the password are generated using the dynamic cipher, the cipher algorithm still has several cipher characters that have not been assigned to any of the plain text characters. Once the user completes all the keystrokes which assign at least one cipher character to each of the typed characters, then the cipher algorithm continues, using a ruleset to assign the unassigned characters.

The cipher algorithm further includes a ruleset which assigns the remaining cipher algorithm characters to the remaining plain text characters. A typical homophonic substitution uses the digits 0-9 in addition to the letters of the alphabet. Because this is more than 26 characters total, the homophonic substitution in a mixed alphabet cipher assigns two characters to the letter “a,” four characters to the letter “e,” two to the letter “i,” two to the letter “n,” two to the letter “o,” two to the letter “s,” and two to the letter “t.” The special characters simply add to the total. Because it is not known exactly how many special characters may be included before a user enters them, the cipher algorithm may include a ruleset as to which alphabet letters get assigned either a second, or more, character of the pool of special characters.

The rules for distributing the special characters may establish a priority list for placement of the special characters in the cipher in relation to the letters of the unencoded alphabet. The ruleset may include that if there is at least one special character, then the letter “h” may receive a second cipher character in addition to the single cipher character already assigned. If there are two special characters, the letter “r” may receive a second cipher character in addition to the single cipher character already assigned. The entirety of the priority list for assigning letters may be, in order of priority from highest to lowest, h, r, e, t, a, o, i, n, and s. If there are additional special characters, the priority list may repeat, meaning that special characters may be assigned, in order, to h, r, e, t, a, o, i, n, and s. If the list has repeated twice, a second cipher character may be assigned to the letter “d” before additional cipher characters are assigned to the above priority sequence again.

Returning to the example, 10 characters will be assigned within the cipher during the password creation process. 26 characters will remain if there are no special characters, and more than 26 will remain if there are special characters being used. Using a random number generator to designate, one at a time, the remaining characters, the above ruleset assigns the remaining characters according to the above ruleset. Once all the characters have been assigned, the cipher is complete.

As shown in Steps 528 and 530, the cipher may be stored in a secure file and uploaded offsite. The secure file may be uploaded to the cloud, or to an offsite server, or a peer machine with separate security, or any machine other than the local machine on which it was created. The secure file may include information which associates the cipher and the files with which the cipher is to be used. The cipher may be used with only one file or it may be used with a plurality of files. This option may be user controllable. Upon creation of the secure file, a pointer may be added to the local software associating the secure file to every file, including websites, with which it is to be used. A pointer may be added to the software on the local machine used in conjunction with the cipher and the secure file on which it is stored. When a file is opened which has a password associated with it, the pointer in the software may reach out to the secure file, obtaining the cipher and placing the cipher in to operation. As the user types the password associated with the file, the cipher encodes the typed password in to the password used with the file.

### Local File Security

The security of local files must address the insider threat, which is the recognized greatest threat to theft of intellectual property via computer files. Computer files in everyday use at a company may include spreadsheet files, presentation files, word processing files, and files of computer code in the process of being written. Each of these files may contain trade secret information, proprietary information, or even patentable subject matter. If such files were to be misappropriated by an insider, considerable damage could be done to the company, including loss of trade secrets and a bar to patenting inventions contained in the files. The best solution is to maintain control and security of such files against an insider threat.

The heart of the security of the disclosed locally stored file security system and method consists of a security check of three parts. All three parts are contained within a script which automatically runs when the file is opened. The first part is for the script to check that the central processing unit identification (CPUID) of the computing device on which the file is being opened is the same as that stored in the script. The second part is that the script also checks that the file is not being opened on a virtual machine. The final part is only in part executed by the script, and for this third check or subroutine, the script asks a server if the local computing device is directly connected to the server, without any traffic passing through any intermediate servers. If any of the three parts is failed, then the file remains encrypted. The files may only be decrypted through a public key encryption scheme when connected directly to a company server.

The CPUID check is one way to determine that the file is running on a specific local machine. Each computer has a central processor. The central processors are given individual serial numbers by the processor manufacturers. When the file is created, the script checks for the serial number, or CPUID, of the processor, and stores that number within the script. Later, when the script is running a check prior to again opening the file, the script checks the CPUID again and compares the just obtained CPUID to the one stored in the script. If the two CPUIDs match, the check is passed, and the script moves on. If the two CPUIDs do not match, the check fails, and the file is not decrypted and opened.

The script next checks several places to determine if the machine on which the file is being opened is a virtual machine. This check is included in the system and method to counter the fact that the physical CPUID number of a local machine may be spoofed on a virtual machine. Without this check, if files were transferred to an external storage device, for example, a portable hard drive, the individual or organization misappropriating the files may create a virtual machine which will provide the same CPUID as the actual machine on which the file was created. However, if virtual machine artifacts are found during this second part of the check performed by the script, the check is failed, and the file is not decrypted and opened on the local machine. In contrast, if no virtual machine artifacts are found, this second part of the check is passed and the script moves on to the third part. The third part may also be called the third check or the third subroutine.

The third part of the check includes providing instructions to a company server to determine if the message sent to the company server include packet header data which would indicate that the test message has passed through other servers before arriving at the company server. This indicates that the local machine has been removed from the company premises and someone is attempting to connect the machine from a remote location. The script asks the server to determine if such artifacts from other servers exist within the packet header. After performing the check, the company service provides an answer. If there are no packet header artifacts, then this part of the check is passed, and the file is decrypted and opened. If the header packet or other part of the message is found to include at least one artifact from another server, then the check is failed and the file is not decrypted or opened on the local machine.

More specifically, the system and method operates to improve the security of locally stored files by including a script with every file created by a user. When a user creates a new file within an application, either by selecting a “new file” option from a dropdown menu, or otherwise creates a new file, in the background a local file security module attaches a script to that file. The script is written ahead of time and attached to the file automatically when the file is created. For example, with a.docx file, the file may be treated as a .zip file, and the script added, and then the file converted back to a.docx file. The script file will be embedded in the .docx file. Other types of files may have the script embedded in a similar or another manner. Regardless of the precise method, attaching scripts to another file is well known in the art, and may be accomplished by one of any of the known methods. The file may have a second script attached. This second script corrupts the file if the first script containing the checks or the second script itself are tampered with. For example, if a misappropriator attempts to delete any of the scripts in order to bypass the checks and gain access to the file.

The file is further automatically encrypted. The script may use an operating system's built in functions to encrypt the file. The script may obtain the password provided by the operating system, while the user being unaware of both the process of encryption and the password number. Alternatively, the file may be encrypted by an encryption scheme embedded in the script itself. The password or key to decrypt the file may be passed to the company server. In order to provide greater security, the password or key to decrypt the file is not stored on the local machine or local computing device.

The messages passed between the local machine and the company server may be encrypted using a public key encryption scheme, for example, an asymmetric encryption scheme. In an asymmetric encryption scheme, the local computing device has a private key, and the company server has a private key. The local computing device and the company server share a public key to pass information between them, but only the private key on either the local computing device or the company server. The file on the local computing device may send information contained in an encrypted message to the company server. The information may include the results of the check.

The company server may decrypt the incoming message and thereby obtain the results of the check. The company server may compare the results from the message with results stored in a memory on the server. If the results do not match, the server may send a return message to the local computing device. The return message may include instructions to display a message to the user that the check was failed, and the file remains encrypted.

Alternatively, if the comparison of the results from the message matches the results stored on the memory of the company server, then the company server may return a message including a key or a script which includes a key to decrypt the file stored on the local computing device. If the company server only returns a key, the script included with the local file may include instructions for using the key to decrypt the file. Alternatively, the company server may send a script to the local computing device. The script may include instructions for decrypting the file on the local computing device.

Once the file is decrypted, it may be used normally. For example, the file may be edited and saved the way any other file of the same type, but not including the encryption script, may be edited and saved. The encryption only affects access to the file, the script and the encryption do not affect the operation of the file once a check has been passed. “Passing” the check is defined as the messaged check results matching the results stored on the company server memory when the two are compared. Once such a check is passed, full access to the file and its parameters is granted.

When the file is closed, or the local computing device is turned off, or the local computing device goes to sleep, another check must be performed and passed to gain access to the file. Such an additional check ensures security of the file because it may be possible for a misappropriator to open the file after passing the check, and then remove a mobile local computing device, such as a laptop, while the file is still open. The user may close the laptop and disconnect from the network, move to a remote location, and awaken the device, and have the file still open. However, because the user closed the laptop, the local computing device was put to sleep, and the file must be unencrypted before additional use. Of course, additional precautions must be taken by the company to either check for, or prevent users adding software to their local computing devices which may subvert such a security scheme. For example, software is made that will prevent a laptop from going to sleep when the laptop is closed.

Further, if a machine is not disconnected from a network using a particular protocol, the machine may be either automatically remotely encrypted or automatically remotely wiped by the company server. Alternatively, remote encryption or remote wiping may be manually implemented by a network administrator. Each option may be effective in conjunction with the disclosed local file security system.

Also, typical anti-malware programs may prevent the script from running, so malware checks may have to be moved to a server-level option, or some measure of additional risk accepted due to the anti-malware software being removed from the local machine. With the server performing malware checks, service processing power and speed may be affected. Thus, it may be necessary to increase the processing power of each of the servers used by a company to compensate for the changes.

Thus, as is shown in FIG. 1, in terms of physical arrangement, the system 10 includes one or more scripts 712 installed on a local file 714 of one or more types saved to a memory of a local machine 716 or computing device. The local machine 716 is connected via a wired or wireless network, or a combination of both 718, to a company server 20. The company server 720 has at least one local file security executable file 722 saved on to a memory 724 of the company server 720.

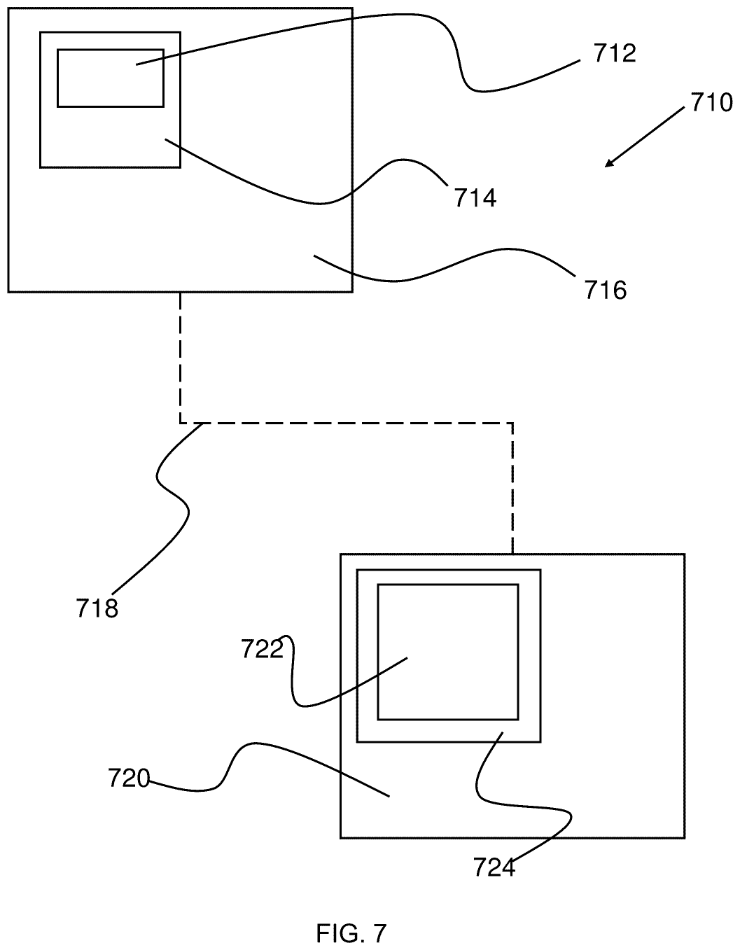

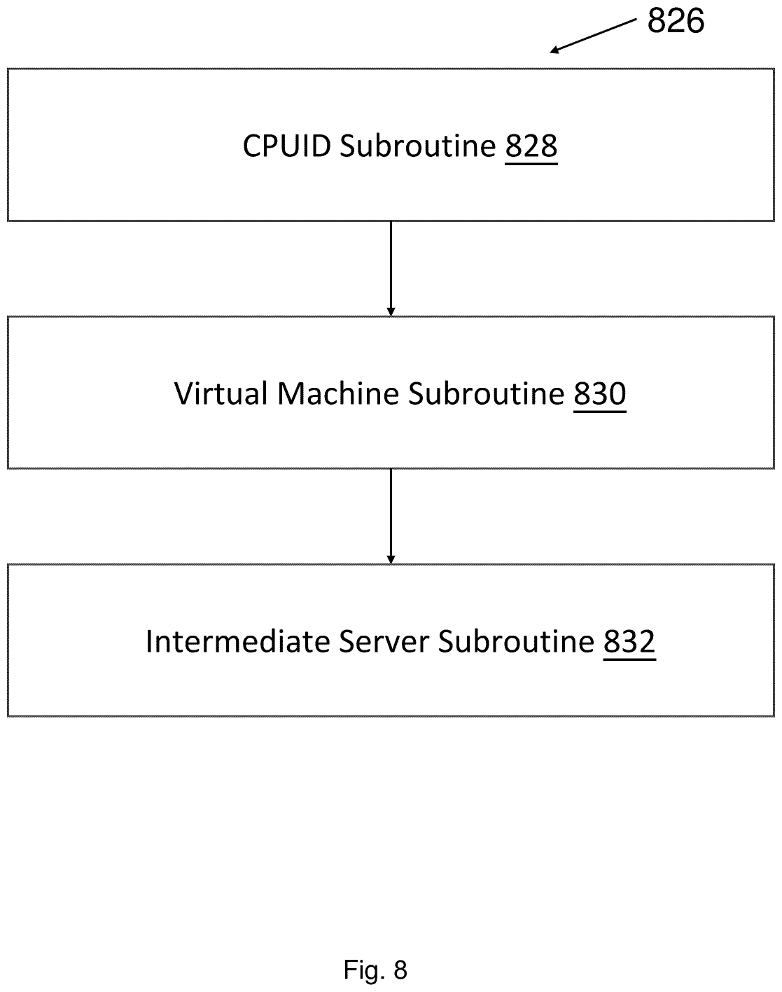

With reference to FIGS. 7 and 8, the script 712, as part of the local file 714, includes a check 726. The check may include three parts or subroutines. The first subroutine 828 may obtain the CPUID of the local computing device, and may compare the CPUID to another CPUID stored in the script when the file was created, and store the result of the comparison in a message for sending to the company server. The second subroutine 830 may check a plurality of locations on the local machine for artifacts that would indicate that the machine on which the file 714 is being opened is a virtual machine. The second subroutine 830 stores in the same message containing the result from the first subroutine 828 whether there is a positive result, that is, that the second subroutine 830 found at least one artifact indicating that the file 714 is being opened on a virtual machine, or a negative result, that is, that the second subroutine 830 did not find any artifacts indicating that the file 714 was being opened on a virtual machine.

The third subroutine 832 may occur on the company server 720 side, because the third part or subroutine 832 requires the analysis of a message passed from the local machine 716 to the company server 720 to determine if the message has passed through one or more intermediate servers. Thus, no result for this third part or subroutine 832 is included in the message sent to the company server 720. Rather, the creation of the message enables the execution of the third part or subroutine once the message reaches the company server 720.

The script 712 may further include instructions to send the message or data for the message to a protocol module. The protocol module may format the message according to one of a number of well know network protocols. For example, the message may be sent using a WiFi® protocol, or a Bluetooth® protocol, or any of a number of other protocols known in the art. The protocol module may further include instructions for the sending the message or data to an encryption protocol. The encryption protocol may encrypt the message according to an asymmetric encryption protocol. Thus, the message may be encrypted using a public key, and may only be decrypted using the company server's private key. Once the message is encrypted and formatted per the network protocol, it may be sent to the company server 720.

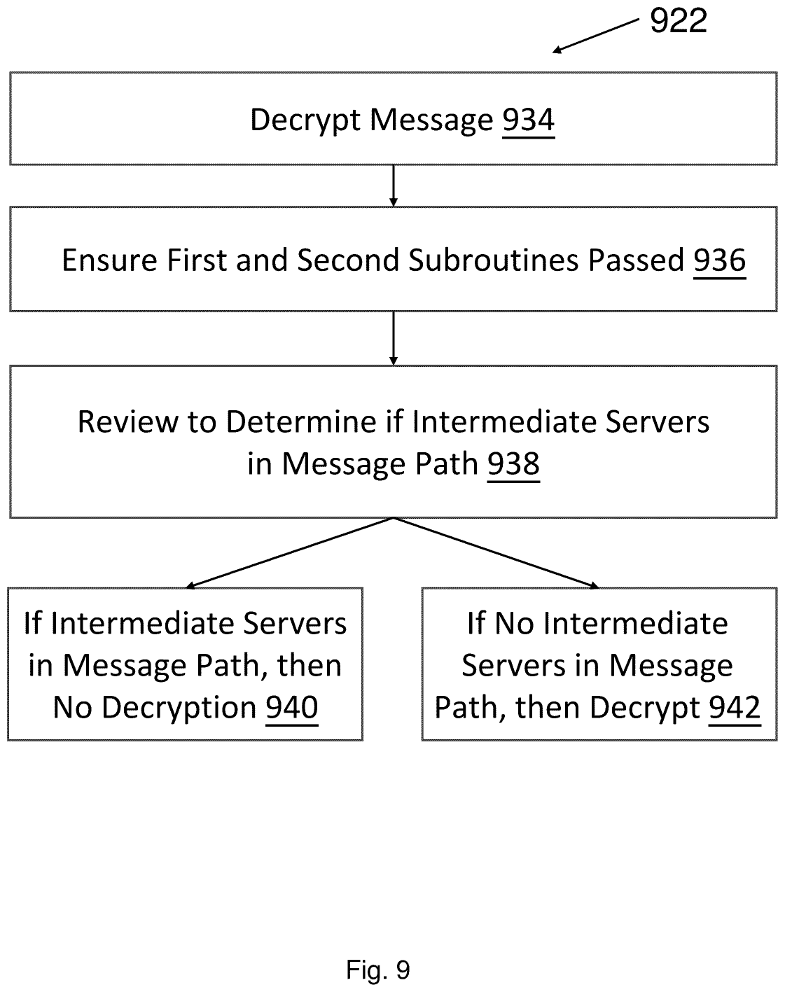

As shown in FIG. 9, the company server may include an executable file 922, which receives the message from the local computing device, and decrypts the message 934 using the public and company server private keys. The public key is used to encrypt the message during transmission, but the message may only be decrypted using the private key of the company server. Once the message is decrypted, the company server may ensure 936 that the first two parts or subroutines of the check have been passed. The executable program on the company server may do so through a review of the data included with the message. The company server may then perform the third part or subroutine. Specifically, the executable program may review 938 the header packet of the message to determine if the message has been through an intermediate server. In Step 940, if there are markers in the packet indicating that the message has been through another server, the company server may a message that the file cannot be decrypted. In contrast, in Step 942, if the review of the message determines that the message has not been through another server, the company server may add information to a return message that will decrypt the file on the local computing device.

Alternatively, the local computing device may not send a message if either of the first two checks are failed. The script may include instructions that prevent any communication with the company server if either of the first two subroutines of the script returns a failed result. The script may include a check before any message is sent to the company server, and, if there is a negative result from either of the two first subroutines, then the script includes instructions to not send the message to the company server. Instead, the script may include instructions that cause the local computing device to display a message to a user of the local computing device that the file cannot be decrypted. The instructions in the script may further prevent any further action on the file, effectively locking the file.

In operation, the system and method start with the creation of any file on a local machine. A local machine may be a laptop, a tablet computing device, or even a desktop computer. Local machines are differentiated from servers, as local machines are meant to meet the needs of a single user. When a file of any type is created by a user and first opened for use, the local machine attaches a script to the file. The type of file may be a word processing document. The file may also be a spreadsheet. The file may be a presentation document, for example, the file could be a Microsoft® PowerPoint® file. The file may also be a database. The file may be a compiler, assembler or linker file containing computer code in the drafting process. If the file is a compiler file, the file may be one for a native code compiler, a cross code compiler, a source to source compiler, an incremental compiler, or a source compiler. The compilers may be for a number of languages, for example, C, C++, and Java. If the file is an assembler file, the assembly language may be that of the host machine, or a non-hosted machine. If the file is a linker file, it may be either a static or dynamic linker. Thus, the file may be any of hundreds of files typically created on a local machine by a user.

The script may automatically encrypt the file. The script may use an operating system's built in functions to encrypt the file. The script may obtain the password provided by the operating system, while the user being unaware of both the process of encryption and the password number. Alternatively, the file may be encrypted by an encryption scheme embedded in the script itself. The password or key to decrypt the file may be passed to the company server. In order to provide greater security, the password or key to decrypt the file is not stored on the local machine or local computing device.

Contemporaneously, as soon as the file is created, the script will attach to the file and may automatically check the CPUID of the machine. Once the CPUID of the machine is determined, the script may record the CPUID in the script. Once the CPUID is recorded, the script may use the recorded CPUID to compare to the retrieved CPUID when the file is opened in the future. In order to obtain the CPUID, the script may have code, or instructions, which interrogates or calls the CPUID. As is well known in the art, the CPUID opcode is OFh, A2h (as two bytes, or A20Fh as a single word). In assembly language, the CPUID instruction takes no parameters as CPUID implicitly uses the EAX register to determine the main category of information returned. In Intel's more recent terminology, this is called the CPUID leaf. CPUID should be called with EAX=0 first, as this will store in the EAX register the highest EAX calling parameter (leaf) that the CPU implements. To obtain extended function information CPUID may be called with the most significant bit of EAX set. Thus, in order to determine the highest extended function calling parameter, CPUID may be called with EAX=80000000h. CPUID leaves greater than 3 but less than 80000000 are accessible only when the model-specific registers have IA32_MISC_DisablE.BOOT_NT4 [bit 22]=0. As the name suggests, Windows NT4 will not boot properly unless this bit is set, but later versions of Windows do not need it, so basic leaves greater than 4 can be assumed visible on current Windows systems. As of July 2014, basic valid leaves go up to 14 h, but the information returned by some leaves are not disclosed in publicly available documentation, i.e. they are “reserved.” Some of the more recently added leaves also have sub-leaves, which are selected via the ECX register before calling CPUID.

In addition to the CPUID check, the script may perform other checks upon creation of the file. The script may cause the local machine to send a message to the company server with data requiring a security check of the message. A check of the message header is required to determine the company server is connected to the local machine directly. The one or more executable programs on the company server may review the message, including, but not limited to, the message header packet, to determine if the message has passed through any other server prior to the company server. These servers through which the message may have passed may also be called intermediate servers because they are located in a message path between the local machine and the company server. If the review of the message by the one or more executable programs does not find any evidence of the message having passed through any intermediate servers, then the one or more executable programs may place data in a message that the file may be made fully functional. The local machine may receive the message and provide the data to the script. The script may then allow full functionality of the file. Before the script receives the data indicating that the file may be made fully functional because the local machine is directly connected to the company server, the file may have functionality limited to formatting and saving. If the company server finds evidence that the message has passed through any intermediate servers, then the company server may cause a message to be sent to the local machine. The message sent to the local machine may cause a message to be displayed to the user which states that the file cannot be opened, and the local machine, through the script, may automatically close the file without saving any contents of the file.

Once the CPUID is stored in the script and the local machine is determined to have a direct connection to the company server, the script is ready to initiate when the file is reopened. The data to which the potential virtual machine artifacts from the plurality of memory locations is compared is automatically populated in the script when the script is created. Further, the instructions for encrypting a message with the results of the above checks and sending the message to the company server are also a pre-programmed part of the script. Thus, once the CPUID is stored in the script, the script is ready to execute any time the file is reopened by a user. The script does not perform continuous checks, but is rather event driven, detecting changes in the way the system is connected or the condition of the local machine until the file is closed.

After the file is created and closed, a user may choose to reopen the file to edit the file, to print the contents, or perform any of a number of possible actions with the file. When the file is opened, the script automatically runs. First, the script may run the CPUID subroutine. That is, in a first step, the script may execute instructions on the processor of the device that determine the CPUID of the machine on which the file is being opened. However, once the CPUID is obtained during the opening of a previously created file, the determined CPUID is not stored, but rather, in a second step, the determined CPUID is compared to the CPUID stored during the creation of the file. In a third step, if the CPUID of the machine on which the file is being opened matches the CPUID stored in the script, the script records that the CPUIDs match. The recordation may be binary. That is, the script may simply record that the subroutine is passed or failed. If the CPUID of the machine on which the file is being opened does not match the CPUID stored in the script, then the script records that the CPUIDs do not match. Again, the recordation may be binary. That is, the script may simply record that the subroutine is passed or failed. Specifically, in these circumstances, the script may record that the subroutine is failed. Next, the script may move on to the next subroutine. Alternatively, if the comparison determined that the CPUIDs do not match, the script may include instructions which cause a message to be displayed to the user that the file cannot be decrypted. The process ends after the message is displayed, and the user has to reinitiate the process by attempting to open the file again.

The script next performs the second part of the check, or runs the second subroutine. The second part of the check or second subroutine may, in a first step, interrogate a plurality of memory locations on the local machine and record what the script finds in the plurality of memory locations. The plurality of locations may include performing a check which obtains the same data the user would obtain if the user checked the hardware of the machine, for example, through a check of the control panel on a Windows® operating system. Similarly, the script may obtain data that would be the same data if the user typed “SYSTEMINFO” in a Windows® CMD window. The script may also obtain the data which would be obtained from an extended “SYSTEMINFO” command, specifically, a “systeminfo findstr/i model.” The script may also include instructions that would obtain the data a user would obtain if the user entered the command “gwmi-q “select * from win32_computersystem” in a powershell. The script may also obtain the data the user would obtain if the user were to enter the command “wmic/node: bios get serialnumber” from a powershell session. The script may further determine all of the running processes on the local machine. On a virtual machine, there will be many indicators of virtual machine processes. The script may also obtain information similar to that which would be obtained on a Linux system using “virt-what.”

The information obtained in the first step may be stored by the script in memory. In a second step, the information obtained and stored may be compared to data stored in the script indicative of a virtual machine. The comparison is performed on a specific data type to specific data type basis. Thus, the data obtained is compared to data stored in the script, and the data stored in the script is representative of data that may be obtained from virtual machines using the exact same techniques as the second subroutine.

The data stored in the script indicating the presence of a virtual machine may be updated from time to time. As operating systems evolve, where these systems store information may change. Moreover, the script may have to be adapted for different or for multiple operating systems. If the script is adapted for multiple operating systems, then it can still provide security even if the file is created on a first operating system, and then later, the same machine is migrated to a different operating system. In addition, if the data indicative of a virtual machine change, those individual entries may need updating for the script in order to function properly, that is, not provide false positives, or indications of a virtual machine when there is not a virtual machine, and to provide correct identification of a virtual machine when one is present.

The script then compares the data found on the local machine to the data indicative of the presence of a virtual machine stored in memory and recalled by the script. If, during the comparison, the script determines that any of the data found on the local machine matches any of the data indicative of the presence of a virtual machine, then the part of the check or subroutine is failed and that result recorded. As with the first subroutine, the result recorded may be binary. That is, the result may be recorded as “pass” or “fail.” If the data found on the local machine does not match any of the data indicative of the presence of a virtual machine, then the check or subroutine is passed, and that result is recorded. Again, as with the first subroutine, the result recorded may be binary. That is, the result may be recorded as “pass” or “fail,” and specifically in this case, as “pass.”

After recording the results, the script may move on to causing the results of the second part of the check or subroutine, along with the results of the first check or subroutine to be placed in a message, and the message encrypted and sent to the company server. Alternatively, if any of the data found on the local machine matches any of the data indicative of the presence of a virtual machine stored in memory by the script, the script may include instructions which cause a message to be displayed to the user that the file cannot be decrypted. The script ends the decryption process after the message is displayed, and the file is closed. The user has to reinitiate the process by attempting to open the file again.

The results of the first and second part of the checks or subroutines may be added to a message as data. The script may include instructions which cause the message to be encrypted. Alternatively, the script may include instructions that send the data to another program or set of instructions stored on the local machine, and that program or set of instructions forms and encrypts the message. The local machine then sends the message to the company server. The message may be sent using any of a number of wired or wireless protocols, or a combination of these protocols known in the art. As noted above, if both the first and second parts of the check or first and second subroutines are passed, the message is sent to the company server. Alternatively, the message may not be formed or encrypted if either of the first or second part of the check or first and second subroutines has sent a message to the user stating that the file cannot be decrypted.

The company server may have one or more executable programs which receive and process the message. Once the one or more executable program has received and processed the message to obtain the data within the message, the one or more executable programs may perform further analysis. The one or more executable programs may receive the message and decrypt the message. The one or more executable programs may review the results to ensure that both the first and second parts of the check or first and second subroutines have been passed.

If the review shows that the first and second parts of the check or first and second subroutines have been passed, then the one or more executable programs may perform further analysis. The one or more executable programs may then review the message, including, but not limited to, the message header packet, to determine if the message has passed through any other server prior to the company server. The servers through which the message may have passed may also be called intermediate servers. The term “intermediate” describes these servers location on a message path between the local machine, or computing device, and the company server. If the one or more executable programs does not find any evidence of the message having passed through any intermediate servers, then the one or more executable programs may place data which will decrypt the file on the local machine in to a message. The one or more executable programs may also encrypt the message and cause the message to be sent to the local machine. If the one or more executable programs finds evidence that the message has passed through any intermediate servers, then the one or more executable programs may cause a message to be sent to the local machine. The message sent to the local machine may cause another message to be displayed to the user which states that the file cannot be decrypted. The message may further cause the file to automatically close after the display of the message.

The local machine may perform further operations to allow use of the file. The local machine may receive the encrypted message. The local machine may decrypt the message, and obtain the data sent by the company server. The data sent by the company server may cause the local file to be decrypted, and made available for editing by the user on the local machine. The availability may continue until the file is closed, the computer is shut down, or enters sleep mode, or is disconnected from the local network.

The script may include instructions for changing the functionality or status of the file if the file is closed, the computer is shut down, or the computer enters sleep mode, or if the computer is disconnected from the local network. If the file is closed, then the check and decryption process begins again when the file is opened. However, if the computer is shut down or enters sleep mode, or the computer disconnected from the company server, without instructions from the script requiring otherwise, the file may still be open, and may be open when the local machine is started again, or is brought out of sleep mode, or used “air gapped,” that is, disconnected from the local network. Thus, the script may include instructions which cause the script to check the status of the local machine's network connection. If the computer is disconnected from the network, it may freeze all functionality of the file other than saving and closing. Alternatively, if the local machine is disconnected from the local network, the script may automatically close the file. The check for connection to the network may be performed at predetermined time periods, for example every five seconds. Predetermined time periods of less than five seconds and greater than five seconds are also contemplated.

The script may further include specific instructions for changing the available functionality, or the status, of the open file if the computer is shut down or enters sleep mode. The script may include instructions which change the available functionality, or the status, of the file in a similar manner if the local machine on which the file is open either enters sleep mode or is shut down. The script may include instructions which cause all the functionality, other than saving the file or closing to the file, to be locked when the file is open, and the computer is restarted, or comes out of sleep mode. Alternatively, the script may cause the file to automatically close if the computer is shut down or enters sleep mode with the file open. Such functionality prevents a user from leaving the file open on the local machine and moving the machine to a different location, away from a direct connection with the company server, and continuing to use the functionality of the file, including copying the contents and moving the contents to another file.

Functionality may be restored to the file by reopening the file. The user may simply close the file, if it is not already closed, and reopen the file, causing the script to run and, if the checks are passed, decrypt the file for use. Alternatively, the user may save and close the file, if it is not already closed, and perform other tasks. Even if the user were to create a new file and transfer the contents, the functionality of the script described above will prevent the new file from accepting the copied contents until the local machine is connected directly to the company server.

### High Data Signal Encoding

While nearly every current encoding scheme concentrates on encoding single cycles of a frequency or even shorter burst transmission, the disclosed encoding scheme uses a combination of orthogonal functions across a single cycle of the lowest frequency in a bandwidth, and multiple cycles in selected higher frequencies to encode and then detect the encoded data. This method and system offers increased data rates compared to other encoding systems, for example, current OFDM encoding, and increased robustness against data loss due to noise and interference.

Specifically, the system and method uses a plurality of orthogonal functions encoded on the lowest, and all even subsequent subcarrier frequencies, in the bandwidth. For example, if an 802.11a wireless standard is being used, the lowest subcarrier frequency, the second lowest, the fourth lowest, sixth lowest, and so on will be encoded to carry additional data using a plurality of orthogonal functions. While the example uses the 802.11a standard, one of ordinary skill in the art will recognize that the system and method will work with any bandwidth of subcarriers, and therefore any OFDM system.

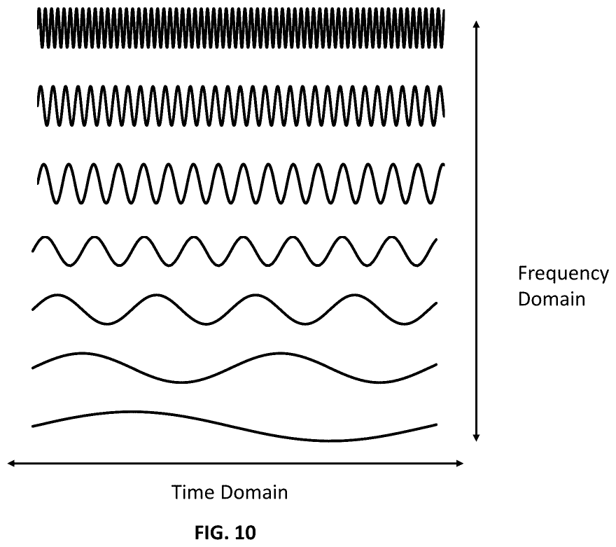

FIG. 10 illustrates a visualization of the subcarriers used by an embodiment of the present disclosure. For illustration purposes, FIG. 10 depicts the embodiment in the context of an 802.11a OFDM protocol in the frequency and time domains. Normally, the 802.11a OFDM includes 64 subcarriers of which 48 are used to carry data, four are used as pilots, and the remainder are used as null. Depending on the encoding scheme and error correction used, the data rate for an 802.11a OFDM ranges from 6 Mbps using BPSK and 1/2 forward error correction (FEC) to 54 Mbps using 16 QAM and 3/4 FEC. Traditional 802.11a OFDM uses a burst transmission. The burst transmission is broken in to several parts. The burst includes a preamble of 16 microseconds in duration, a signal portion of one OFDM symbol of four microseconds in duration, and one or more data symbols, each of four microseconds in duration. Each subcarrier is spaced 312.5 kHz from the other subcarriers in the frequency domain.

In contrast, the embodiment of the disclosure illustrated in FIG. 1 uses only seven subcarriers. The subcarriers are chosen because each subcarrier frequency can support a plurality of signals using two or more functions, all of which are orthogonal to one another. Further, the plurality of signals at each subcarrier are orthogonal to the plurality of signals on all the other subcarriers. Thus, the six subcarriers can each carry an amount of data corresponding to the number of cycles in the transmission time. The transmission time is the time required to transmit a single cycle of the lowest frequency subcarrier. Although the lowest frequency subcarrier is not used for transmission, it is used to set the overall time of a transmission. For example, the first subcarrier, or lowest frequency subcarrier in the 20 MHz 802.11a OFDM bandwidth controls. The subcarriers which are powers of two are used as subcarriers. Thus, the six subcarriers would be the second subcarrier, the fourth subcarrier, the eighth subcarrier, the sixteenth subcarrier, the thirty-second subcarrier, and the sixty-fourth subcarrier.

Because the disclosed embodiment makes much more efficient use of the time domain for each of the subcarriers, the data rate may be greatly increased as compared to the standard 802.11a OFDM data rates. Again, the data rate increase is achieved despite dropping from 48 subcarriers to seven subcarriers. Using BPSK and 1/2 FEC, the disclosed embodiment the data rate for this embodiment of the disclosure is 682.5 Mbps, and using 64QAM and 3/4 FEC, it is 6142.5 Mbps. In both cases, the disclosed embodiment outperforms the state of the art 802.11a OFDM by more than two orders of magnitude of the data rate while using the same bandwidth and fewer subcarriers. The burst transmission is replaced by a transmission length of one cycle of the lowest frequency in the bandwidth. This increase in data rate is solely due to more efficient use of the time domain, and specifically, the ability to encode all the cycles of the higher frequencies in the bandwidth.

Additional hardware requirements are minimal. The same bandpass filter for the 20 MHz bandwidth may be used. The same processors, transmitters, and receivers may be used. Largely, the changes may be software related.

In order to encode the data, pairs of orthogonal functions are used. Each pair of orthogonal functions may be integrated through the transmission period in order to recover the coefficients for the data. Thus, in addition to the use of some subcarriers in the OFDM scheme, the embodiment further makes use of orthogonal multiplexing of each of the seven subcarrier frequencies.

The mathematical principles behind the multiplexing of each individual frequency are discussed below.

We will start with the case of the second subcarrier frequency, as the number of functions to be mixed are fewer, and therefore more easily understood. However, one of ordinary skill in the art can extrapolate for the remainder of the frequencies. The second subcarrier frequency completes two cycles in the time the first subcarrier frequency completes one cycle. This may be understood by reviewing the frequency separation. If the first subcarrier is at 312.5 kHz, then the second subcarrier is at double that frequency, 625 kHz, or 312.4 kHz +312.5 kHz. Thus, we will be able to obtain two symbols from the second subcarrier wave. We start with four expressions:

$$F 1 ( t ) = \{ \begin{matrix}A 1 ( t ) sin ( ω t + Φ ) , & 0 < t \leq T \\ A 1 ( t ) sin ( ω t + Φ ) , & T < t \leq 2 T\end{matrix} \\ F 2 ( t ) = \{ \begin{matrix}A 2 ( t ) sin ( ω t + Φ ) , & 0 < t \leq T \\ - A 2 ( t ) sin ( ω t + Φ ) , & T < t \leq 2 T\end{matrix} \\ G 1 ( t ) = \{ \begin{matrix}A 3 ( t ) cos ( ω t + Φ ) , & 0 < t \leq T \\ A 3 ( t ) cos ( ω t + Φ ) , & T < t \leq 2 T\end{matrix} \\ G 2 ( t ) = \{ \begin{matrix}A 4 ( t ) cos ( ω t + Φ ) , & 0 < t \leq T \\ - A 4 ( t ) cos ( ω t + Φ ) , & T < t \leq 2 T\end{matrix}$$

where ω is the frequency, “t” is time, and Φ is the phase at the frequency. T is the period or cycle of the frequency. The period may be half a cycle or a full cycle. The above example defines T as a half cycle, and, thus, the coefficients are maintained throughout each period. However, when the period is defined as a full cycle, the coefficients may be varied for the second period. It is the choice of the user as to how to define the period. As discussed above, the second subcarrier has two cycles for every one of the first subcarrier, however, this has no bearing on the definition of the period, T. As shown above, the functions change from the first period to the second period. Depending on the subcarrier frequency, the functions may all be different for each of the periods or cycles, or the functions may repeat after a predetermined number of periods or cycles.

It can be shown that these functions are orthogonal at the 2T period end. As a result, these functions can be sent concurrently, encoding the coefficients A1-A4. To make the orthogonality in combination more clear, we may combine the Sine and Cosine functions, yielding:

$$Q 1 ( t ) = \{ \begin{matrix}A 1 ( t ) sin ( ω t + Φ ) + A 3 ( t ) cos ( ω t + Φ ) , & 0 < t \leq T \\ A 1 ( t ) sin ( ω t + Φ ) + A 3 ( t ) cos ( ω t + Φ ) , & T < t \leq 2 T\end{matrix} \\ Q 2 ( t ) = \{ \begin{matrix}A 2 ( t ) sin ( ω t + Φ ) + A 4 ( t ) cos ( ω t + Φ ) , & 0 < t \leq T \\ - A 2 \{ ( t ) sin ( ω t + Φ ) + A 4 ( t ) cos ( ω t + Φ ) \} , & T < t \leq 2 T\end{matrix}$$

The signals corresponding to the various sine and cosine functions may be transmitted by using either a switching system using logic gates, or may be combined before transmission and queued for transmission. For example, there may be a transmission side buffer which queues as many functions as necessary to allow the processor to stay ahead of the cyclic requirements. Because each frequency has differing cyclic requirements, and specifically, because these requirements vary exponentially from the lowest frequency subcarrier to the highest frequency subcarrier, the combined processing of all the subcarriers must be taken in to account, but one of ordinary skill in the art will recognize that the requirement will be primarily driven by the highest frequency subcarrier. Preparation of such signals are already well known in the art, as QAM modulation or encoding techniques require the preparation of such functions before transmission. The functions may be assembled serially based on a clock signal which has the same frequency as the highest frequency subcarrier.

The signal, created by combining a series of one or more functions with combined orthogonal functions of sine and cosine per cycle, is transmitted simultaneously with the other functions for that frequency. For example, if the frequency of the subcarrier has 16 cycles for every one of the lowest frequency subcarrier, then there is a set of 16 functions, or a set of 16 combined series of sine and cosine functions, similar to those shown in Q1(t) and Q2(t) above. The set is transmitted and received along with all the other sets of functions on the other frequencies. There is no need to filter beyond the bandwidth filter because each function within the set is orthogonal to all the other functions or series of functions for the transmission.

As one of ordinary skill in the art will recognize, the sets of functions described above can be both internally and externally orthogonal. For example, each set of functions for a subcarrier may be orthogonal for the number of cycles in that frequency equal in time to one cycle of the lowest frequency subcarrier. A single cycle of the lowest frequency subcarrier defines a transmission interval. For example, the sixty-fourth subcarrier may have 64 cycles for every one cycle of the first subcarrier. Further, the sets of functions are externally orthogonal as well. That is, the set of functions or series of functions on any one of the subcarriers is orthogonal to all the other sets of functions or series of functions on the other subcarrier frequencies. Thus, when integrated over the transmission interval, all of the coefficients form the functions may be recovered, thereby recovering all of the data.

The coefficients may be stored in a memory. Each pair of coefficients, for example A1 and A3, and A2 and A4 from the example above, may represent a symbol in an encoding scheme. Depending on the encoding scheme, the symbol can represent just one bit, and as many as eight bits. The limitation with encoding more information is that as the individual coefficients get closer and closer to each other, they are more difficult to distinguish between each of the symbols, especially if there is any noise or interference with the signal. For example, binary phase shift keying (BPSK) may use just two symbols. Each symbol represents a single bit, either one or zero. The first symbol may represent a first of the one or zero, and a second symbol represents the other of the one or zero. With BPSK, at least one of the coefficients will be zero, leading to case of detectability at the cost of decreased data. Encoding schemes are increasingly more complex after the two symbol BPSK scheme. Without providing examples from every encoding scheme, all of which are well known in the art, a higher order encoding scheme is 64QAM. That is, an encoding scheme which varies amplitude and phase to encode symbols. As the name implies, 64QAM has 64 symbols, each corresponding to a unique combination of a string of ones and zeros. Because there are 64 possible combinations, 64 QAM can encode six bits per symbol.

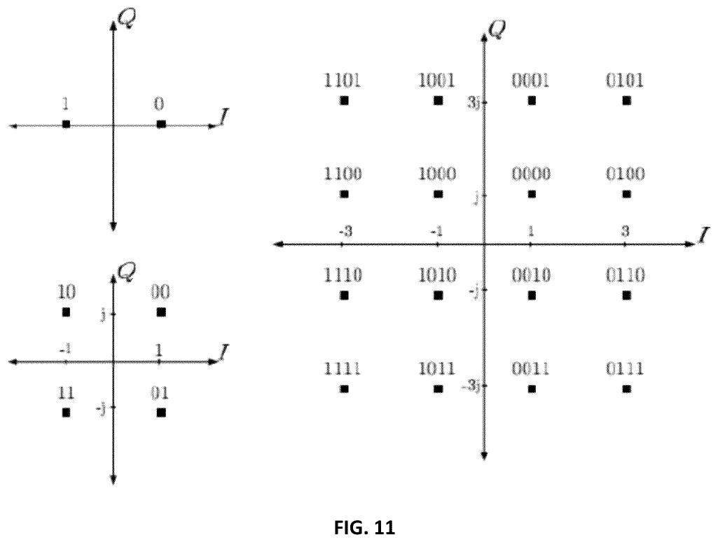

FIG. 11 shows an example matrix of combinations of symbols. In a 16×16 matrix of combinations, 256 possible combinations are possible, which allows 8 bits to be encoded. Thus, 8 bits may be encoded across two cycles. Or, 4 bits/cycle. If there are two functions, 8 bits may be encoded per cycle. In a second example, meaning may be encoded in both the first and second cycles, which could be 4 bits per symbol, or eight bits for the two symbols. If the encoded point has further meaning in combination with an encoded point in the next cycle, the 8 bit encoding may be improved. 256 combinations allows 8 bits to be encoded. Thus, 8 bits may be encoded across two cycles. That is, 8 bits from the 16QAM in each cycle, and 8 additional bits for the combination across two cycles. This could be 16 bits total for two cycles.

Some of the bits are used for forward error correction (FEC), and this will reduce the overall data rate. The amount of data used for error correction is not set. There are multiple forward error correction schemes and each is compatible with any of the encoding schemes.

Each of the functions shown in Q1 or Q2 may be encoded with any encoding scheme. BPSK may be used when lower data rates are acceptable, but higher reliability is a desired benefit. Any form of QAM may be used as well. For example, 16 QAM may be used. In the case of Q1, the coefficients of A1 and A3 would encode the 16QAM symbol. Per the 16 QAM encoding scheme, that symbol would then provide four bits of data. The coefficients may change in the time domain. That is, coefficients A1 and A3 for 0<t<T may not be the same as A1 and A3 for T<t<2T. This allows for encoding of a different symbol in every cycle of the subcarrier. Because every cycle of the subcarrier may be encoded, much more data may be sent during the transmission, especially on higher frequency subcarriers.

Alternatively, or in addition, other subcarriers may be used. In order to use more than the six subcarriers discussed above, a filter will be required to remove the subcarrier from the combined signal before the other six subcarriers can be decoded. However, filters are fairly low cost devices, and by using one or more of the highest frequency subcarriers in this manner, the overall data rate may be significantly improved.

For example, the sixty-third subcarrier may be used with a filter. The sixty-third subcarrier can send 63 symbols in the transmission period. An extra 63 symbols provide almost another 50% of data. Thus, by adding a single filter, the data rate changes almost 150%. Of course, additional subcarriers may be added, as long as they are independently filtered prior to the base six subcarriers being decoded. There is no need for these additional subcarriers to transmit signals which are orthogonal to one another as the sets of functions on the base six subcarriers are. Each of the separately filtered subcarriers is essentially a single carrier. However, these single carriers are arranged within the bandwidth of the OFDM scheme. For example, with the 20 MHz OFDM scheme used in the 802.11a standard, the single carriers may be chosen from among those at the upper end of the bandwidth. With the sixty-third and sixty-second subcarriers being used, the data rate may be nearly doubled.

In some embodiments, the system may include reducing the overall bandwidth by using only consecutive subcarriers at the upper end of the bandwidth. For example, one possibility may be using the sixty through sixty-fourth subcarriers. Each subcarrier would require a separate filter in order to prevent interference between the signals in decoding. However, this multi-single carrier approach would allow the highest frequencies of the bandwidth to be used while also making more efficient use of each of the cycles in the higher frequencies. Thus, data rate is also increased by using three or more of these frequencies.

Because as few as three frequencies may be used, while still obtaining a higher data rate, the overall bandwidth used may be greatly reduced. For example, the typical 20 MHz bandwidth in an 802.11a standard is divided in to 64 subcarriers spaced 312.5 kHz apart. Four of these subcarriers are used as pilots which ensure data integrity, and 48 are used to carry data, the remainder are null. Thus, some of the 64 subcarriers are not used for any data. Part of the bandwidth goes unused either to offer guard bands, or for other reasons.

### Example Embodiments

Below is a list of nonlimiting examples of implementations of the description above.

### Group 1

In a 1st Example, a method for sending commands and data between devices, comprising: creating one or more text language elements on a first device by converting computer executable code in to the one or more text language elements; sending, using a first copy of a wired or wireless protocol executed by a first processor on a first device, a message carrying the one or more text language elements, from the first device to a second device; and providing, on the second device, a text language element application including a library of text language elements, the second device further including a port for receiving the message, a second copy of the wired or wireless protocol, a second processor, and a second memory; the second device being adapted to receive the message at the port, extract, using the corresponding wired or wireless protocol executed on the second processor, the one or more text language elements from the message, and, using the provided text language application executed on the second processor, match the one or more text language elements to corresponding text language elements in the library of text language elements, and translate the one or more text language elements to computer code executable on the second device.

In a 2nd Example, the method of Example 1, wherein the second device transmits commands to operate the first device using text language elements.

In a 3rd Example, the method of Example 2, wherein the first device includes embedding coding which translates the text language elements.

In a 4th Example, the method of Example 3, wherein the embedded coding executes the translated commands.

In a 5th Example, the method of any of Examples 1-4, wherein the text language element application beings operating when the second device is powered on.

In a 6th Example, the method of any of Examples 1-5, wherein the library of text language elements is expandable.

In a 7th Example, the method of any of Examples 1-6, wherein the peripheral device and the computing device exchange messages using the TCP/IP protocol.

In an 8th Example, a method for operating devices using text language syntax, comprising: creating one or more text language elements on a first device by converting computer executable code in to the one or more text language elements; sending, using a first copy of a wired or wireless protocol executed by a first processor on a first device, a message carrying the one or more text language elements, from the first device to a second device; and providing, on the second device, a text language module including a library of text language elements, the text language module being integrated with an operating system according to which the second device operates; the second device further including a port for receiving the message, a second copy of the wired or wireless protocol, a second processor, and a second memory; the second device being configured to receive the message at the port, extract, using the corresponding wired or wireless protocol executed on the second processor, the one or more text language elements from the message, and, using the provided text language module executed on the second processor, matching the one or more text language elements to corresponding text language elements in the library of text language elements, and convert the one or more text language elements to commands to computer code executable on the second device.

In a 9th Example, the system of Example 8, wherein the text language element module further includes executable computer code corresponding to each of the text language elements in the library.

In a 10th Example, the system of any of Examples 8-9, wherein the first device and the second device exchange messages using the TCP/IP protocol.

In a 11th Example, the system of Example 10, wherein the text language element includes a command.

In a 12th Example, the system of any of Examples 8-11, wherein the text language element includes both commands and data.

In a 13th Example, a method for sending commands and data within a computing device, comprising: coding a text language application including a text language element library, the text language element library including one or more text language elements; adding a text language application to a device, the device including at least one processor, one or more memories, an operating system stored in the one or more memories, the operating system being executed by the at least one processor; adding a user operated application to the device by storing it on the one or more memories; and opening and operating the user operated application on the device; wherein, when the user operated application is opened and operated, the user operated application sends one or more text language elements to the text language application, which, using the text language application, converts the text language elements in to code executable on the operating system.

In a 14th Example, the system of Example 13, wherein the one or more text language elements include commands.

In a 15th Example, the system of any of Examples 13-14, wherein the one or more text language elements include data.

In a 16th Example, the system of Example 15, wherein the one or more text language elements include commands.

In a 17th Example, the system of any of Examples 13-16, wherein the text language element library includes computer executable code stored in a one to one correspondence with each of the one or more text language elements.

In a 18th Example, the system of any of Examples 13-17, wherein the device is a mobile device.

In a 19th Example, the system of any of Examples 13-18, wherein the device is a desktop computer.

In a 20th Example, the system of any of Examples 13-19, wherein the text language application may be updated by adding an updated text language element and computer executable code in a one to one correspondence with the updated text language element to the text language element library.

### Group 2

In a 1st example, a method for encoding passwords using a dynamic cipher, comprising: loading a cipher algorithm on to a non-transient memory; inputting a total number of characters included in a password to the cipher algorithm; inputting whether one or more capital letters are required for inclusion in the password, and if the input indicates capital letters are required for inclusion, how many capital letters are required for inclusion; inputting whether one or more numbers are required for inclusion in the password, and if the input indicates numbers are required for inclusion, how many numbers are required for inclusion; inputting whether one or more special characters are required for inclusion in the password, and if the input indicates numbers are required for inclusion, inputting the special characters available for inclusion; forming the alphabet, digits 0 through 9, and the special characters, if any are input, in to a group of available cipher characters; scrolling, automatically, through the group of available cipher characters, each cipher character in the group of available cipher characters available for assignment by keystroke during a predetermined time interval; initiating the creation of the cipher by assigning the cipher character available for assignment to a plain text letter by making a keystroke on an input device; executing additional keystrokes to assign characters available for assignment to each of the other characters of the password; and creating a secure file including the cipher.

In a 2nd example, the method of Example 1, wherein the group of available characters is randomly ordered.

In a 3rd example, the method of any of Examples 1-2, further comprising storing the secure file in the cloud.

In a 4th example, the method of any of Examples 1-3, further comprising storing the secure file on a server remote from computing device.

In a 5th example, the method of any of Examples 1-4, wherein each of the capital letters, if any, are assigned a character position within the password by a random number generator.

In a 6th example, the method of any of Examples 1-5, wherein each of the numbers, if any, are assigned a character position within the password by a random number generator.

In a 7th example, the method of any of Examples 1-6, wherein each of the special characters, if any, are assigned a character position within the password by a random number generator.

In a 8th example, a method for encoding passwords using a dynamic cipher, comprising: loading a cipher algorithm on to a non-transient memory; inputting a total number of characters included in a password to the cipher algorithm; inputting character type requirements within the password to the cipher algorithm; forming the alphabet, digits 0 through 9, and the special characters, if any are input, in to a group of available cipher characters; scrolling, automatically, through the group of available cipher characters, each cipher character in the group of available cipher characters available for assignment by keystroke during a predetermined time interval; initiating the creation of the cipher by assigning the cipher character available for assignment to a plain text letter by making a keystroke on an input device attached to a computing device; executing additional keystrokes to assign cipher characters available for assignment to each of the other characters of the password; and creating a secure file including the cipher.

In a 9th example, the method of Example 8, wherein the character type requirements within the password whether the password requires capital letters, numbers, or special characters, or a combination of some or all of the capital letters, numbers, and special characters.

In a 10th example, the method of Example 9, wherein the character type requirements within the password further include, if the password requires capital letters, numbers, or special characters, or a combination of some or all of the capital letters, numbers, and special characters, a specific number of each type required.

In a 11th example, the method of Example 10, wherein for each of the required of the capital letters, numbers, and special characters, a random number generator determines a character position within the password, and assigns a ruleset to that character position for the type of character determined for that character position.

In a 12th example, the method of any of Examples 8-11, further including assigning, by the cipher algorithm, the unassigned characters to plain text letters to complete the cipher.

In a 13th example, a method for dynamically creating a second password from a first password, comprising: determining a total number of characters in a password; assigning positions to each character in the password; determining requirements for the password, including a number of capital letters, a number of digits, and a number of special characters; inputting, if any are required, a list of special characters; using a random number generator determining a character position for each of the capital letters, digits, and special characters required; assigning one of a corresponding capital letter, digit, and special character ruleset to each of the assigned positions within the password; assigning a global ruleset to the each of the unassigned character positions within the password; using the letters of the alphabet, digits 0 through 9, and, if required, the input list of special characters to create a set of cipher characters; randomizing the set of cipher characters; changing the cipher character available for assignment according to the ruleset assigned to each character position through a keystroke by maintaining the availability of each of the cipher characters in the set of cipher characters for a predetermined time period; and assigning the password by making a keystroke of an input device for each of the character positions in the password, the keystroke assigning one cipher character of the set of cipher characters to the plain text character corresponding to the input device key.

In a 14th example, the method of Example 13, further comprising assigning each of the unassigned cipher characters in the set of cipher characters to a plain text character according to an assignment ruleset.

In a 15th example, the method of Example 14, wherein the completed cipher is stored in a secure computer file in a remote location.

In a 16th example, the method of any of Examples 13-15, wherein the predetermined time period is one tenth of a second.

In a 17th example, the method of any of Examples 13-16, wherein the cipher algorithm ignores previously assigned character positions in assigning further assigned character positions.

In an 18th example, the method of any of Examples 15-17, wherein the secure computer file includes a pointer back to the files with which the cipher is associated.

In a 19th example, the method of any of Examples 13-18, wherein the total number of characters are input by a user.

In a 20th example, the method of any of Examples 13-19, wherein the number ruleset will only allow numbers not previously assigned in one of the global character positions or one of the assigned character positions to be assigned by a keystroke.

### Group 3

In a 1st Example, a system for local computer file security, comprising: a script attached to an encrypted file on a local computing device, the script including a first subroutine, a second subroutine, and a third subroutine, wherein: the first subroutine includes instructions configured to determine a first CPUID of the local computing device on which the file is being opened and to compare the first CPUID against a second CPUID stored in memory by the script to determine if there is a match between the first CPUID and second CPUID, the first subroutine recording a result of the CPUID comparison; the second subroutine includes instructions configured to obtain a first set of data by interrogating a plurality of locations and to compare the first set of data with a second set of data stored in memory, the second set of data indicating the file is being opened on a virtual machine, and record the result of the comparison; the third subroutine includes instructions configured to place the recorded results of the first and second subroutines in a message; an encryption routine configured to encrypt the message; a communication protocol which sends the message; a company server including a memory, the company server electrically connected to the local computing device without any intervening servers and including a copy of the communication protocol; and an executable file stored on the memory, the executable file including instructions which decrypt the message and check the results of the first and second subroutines, if the results indicate that the CPUIDs matched, and the file was not being opened on a virtual machine, then performing an intermediate server check, if the results indicated that either the CPUIDs didn't match, or that the file was being opened on a virtual machine or both, then returning a message to the local computer that the file cannot be decrypted; wherein the intermediate server check includes a review of the message to determine if the message includes any artifacts indicating that the message passed through another server before arriving at the company server, and if the message does not include any artifacts, encrypting a message including data that will decrypt the file, or, if the message is determined to include artifacts indicating the message passed through another server, returning a message indicating that the file cannot be decrypted.

In a 2nd Example, the system of Example 1, wherein the second subroutine includes checking for a mouse and keyboard attached to the local computer.

In a 3rd Example, the system of any of Examples 1-2, wherein the encryption routine is an asymmetric encryption scheme.

In a 4th Example, the system of Example 3, wherein the encryption routine is an S/MIME asymmetric key algorithm.

In a 5th Example, the system of any of Examples 1-4, wherein the script includes instructions which affect an available functionality or status of the file if the local machine is disconnected from the company server, the local machine enters sleep mode, or the local machine is powered off.

In a 6th Example, the system of Example 5, wherein the script automatically closes the file if the local machine is disconnected from the company server, the local machine enters sleep mode, or the local machine is powered off.

In a 7th Example, the system of any of Examples 5-6, wherein the script reduces the functionality of the file to saving and closing if the local machine is disconnected from the company server, the local machine enters sleep mode, or the local machine is powered off.

In a 8th Example, a method for providing local file security, comprising: determining a first CPUID of a machine opening the file; comparing the first CPUID to a second CPUID stored in a script on the file; interrogating a first set of data in a plurality of memory locations on the machine opening the file; comparing the first set of data to a second set of data stored a memory by the script, the second set of data including artifacts indicative of a virtual machine; placing results of the comparison in a message for sending to a company server; encrypting the message; sending the message to the company server; and decrypting the message on the company server; wherein if the results are a match for the CPUID and not a match for the virtual machine, checking the message header to determine if the message has passed through an outside server before arriving that the company server, and if the results are not a match for the CPUID or a match for the virtual machine, or both, sending a message to the local machine causing a message saying the file cannot be decrypted to display; and wherein, if the message has not passed through an outside server before the company server, the company server sends an encrypted message to the local machine with instructions which decrypts the file.

In a 9th Example, the method of Example 8, wherein the interrogating data in a plurality of memory locations on the machine opening the file includes checking the BIOS version to virtual machine indicators.

In a 10th Example, the method of any of Examples 8-9, wherein encrypting the message comprises encrypting the message asymmetrically.

In a 11th Example, the method of any of Examples 8-10, wherein the script automatically closes the file if the local machine is disconnected from the company server, the local machine enters sleep mode, or the local machine is powered off.

In a 12th Example, the method of any of Examples 8-11, wherein the script reduces a functionality of the file to saving and closing if the local machine is disconnected from the company server, the local machine enters sleep mode, or the local machine is powered off.

In a 13th Example, a system for maintaining local file security, comprising: a local machine including a first memory and a processor; and a script attached to a file stored on the memory, the script including instructions for execution on the processor, the instructions including a check, the check including: a first part which finds a first CPUID of a machine on which the file is being opened and compares the first CPUID to a second CPUID stored in the script, if the first CPUID matches the second CPUID, then the first part of the check is passed and the result recorded, if the first CPUID does not match the second CPUID, then the check is failed and the result recorded; a second part which reviews of a plurality of memory locations on the local machine for artifacts indicating the machine is a virtual machine, comparing a first set of data found in the plurality of memory locations to a second set of data stored in the script, and recording the result, if any of the first set of data from the plurality of locations matches any of the second set of data then the check is failed and the result recorded, if none of the first set of data matches any of the second set of data, then the second part of the check is passed and the result is recorded; a third part of the check which determines if either of the first part of the check or second part of the check was failed, and if either or both of the first part of the check and second part of the check were failed, then displays text stating that the file cannot be decrypted, if the first part of the check and second part of the check are both passed, then encrypts and sends a first message to a company server including the information that both the first part of the check and second part of the check were passed; an executable file stored on a second memory on the company server, the company server including a processor for executing instructions from the executable file, the instructions including: a first subset of instructions which receives and decrypts the message; a second subset of instructions which check the message to determine if the message passed through another server before arriving at the company server; a third subset of instructions which, if no indications of the first message passing through another server before arriving at the company server were found, creates an encrypted second message including instructions to decrypt the file, and causes the encrypted second message to be sent to the local machine; and a fourth subset of instructions which, if an indication of the first message passing through another server before arriving at the company server is found, sends a third message to the local machine which causes text to be displayed stating that the file cannot be decrypted.

In a 14th Example, the system of Example 13, wherein the local machine is electrically connected to the company server by a wired or wireless connection, or a combination of a wired and wireless connection.

In a 15th Example, the system of any of Examples 13-14, wherein the second check includes a review of the BIOS information of the local machine.

In a 16th Example, the system of any of Examples 13-15, wherein the encrypting is accomplished using an asymmetric encryption routine.

In a 17th Example, the system of any of Examples 13-16, wherein the file is a word processing document.

In a 18th Example, the system of any of Examples 13-17, wherein the file is a compiler or assembler file.

In a 19th Example, the system of any of Examples 13-18, wherein the script automatically closes the file if the local machine is disconnected from the company server, the local machine enters sleep mode, or the local machine is powered off.

In a 20th Example, the system of any of Examples 13-19, wherein the script reduces a functionality of the file to saving and closing if the local machine is disconnected from the company server, the local machine enters sleep mode, or the local machine is powered off.

### Group 4

In a 1st Example, a method for transmitting data using orthogonal frequency domain multiplexing, the method comprising: identifying a lowest frequency subcarrier in an orthogonal frequency division multiplexing bandwidth comprising 64 subcarriers; selecting the second, fourth, eighth, sixteenth, thirty-second, and sixty-fourth subcarriers in the orthogonal frequency division multiplexing bandwidth; preparing a set of orthogonal functions for each of the second, fourth, eighth, sixteenth, thirty-second, and sixty-fourth subcarriers; encoding, using the sets of orthogonal functions, data on each cycle of the second, fourth, eighth, sixteenth, thirty-second, and sixty-fourth subcarriers with data in a transmission interval; transmitting the second, fourth, eighth, sixteenth, thirty-second, and sixty-fourth subcarriers over a transmission interval; receiving the second, fourth, eighth, sixteenth, thirty-second, and sixty-fourth subcarriers using a bandpass filter; decoding the set of orthogonal functions for each of the second, fourth, eighth, sixteenth, thirty-second, and sixty-fourth subcarriers; and combining the decoded data to recover the transmitted data.

In a 2nd Example, the method of Example 1, wherein at least one additional subcarrier carries a pilot signal.

In a 3rd Example, the method of any of Examples 1-2, wherein each set of orthogonal functions is both internally orthogonal and externally orthogonal.

In a 4th Example, the method of any of Examples 1-3, wherein the transmission interval comprises, for each subcarrier frequency, a number of cycles corresponding to the interval of one cycle of the lowest frequency subcarrier.

In a 5th Example, the method of any of Examples 1-4, further comprising transmitting a guard interval.

In a 6th Example, the method of any of Examples 1-5, wherein combining the decoded data to recover the transmitted data comprises combining the decoded data from each of the second, fourth, eighth, sixteenth, thirty-second, and sixty-fourth subcarriers.

In a 7th Example, the method of Example 6, wherein combining the decoded data from each of the second, fourth, eighth, sixteenth, thirty-second, and sixty-fourth subcarriers comprises identifying common data from at least two of the second, fourth, eighth, sixteenth, thirty-second, or sixty-fourth subcarriers.

In a 8th Example, a method for transmitting data, comprising: defining a set of 64 subcarriers in order to form an orthogonal frequency division multiplexing bandwidth; identifying a lowest frequency subcarrier in the orthogonal frequency division multiplexing bandwidth, setting a transmission interval equal to one cycle of the lowest frequency subcarrier; selecting the second, fourth, eighth, sixteenth, thirty-second, and sixty-fourth subcarriers and at least one additional subcarrier in the orthogonal frequency division multiplexing bandwidth; preparing a set of orthogonal functions for each of the second, fourth, eighth, sixteenth, thirty-second, and sixty-fourth subcarriers, each set of orthogonal functions being both internally orthogonal and externally orthogonal; preparing a set of functions for the at least one additional subcarrier; encoding, using the sets of orthogonal functions, data on every cycle of the second, fourth, eighth, sixteenth, thirty-second, and sixty-fourth subcarriers in the transmission interval; encoding, using the set of functions, the at least one additional subcarrier with data on each cycle of the at least one additional subcarrier in the transmission interval; transmitting the second, fourth, eighth, sixteenth, thirty-second, sixty-fourth, and at least one additional subcarriers over a transmission interval; receiving the second, fourth, eighth, sixteenth, thirty-second, sixty-fourth, and at least one additional subcarriers using a first bandpass filter; filtering the at least one additional subcarrier using a second bandpass filter; decoding the set of orthogonal functions for each of the second, fourth, eighth, sixteenth, thirty-second, and sixty-fourth subcarriers; decoding the set of functions for the at least one additional subcarrier; and combining the decoded data to recover the transmitted data.

In a 9th Example, the method of Example 8, wherein the at least one additional subcarrier carries a pilot signal.

In a 10th Example, the method of any of Examples 8-9, wherein each set of orthogonal functions is both internally orthogonal and externally orthogonal.

In a 11th Example, the method of any of Examples 8-10, further comprising transmitting a guard interval.

In a 12th Example, the method of any of Examples 8-11, wherein combining the decoded data to recover the transmitted data comprises combining the decoded data from each of the second, fourth, eighth, sixteenth, thirty-second, and sixty-fourth subcarriers.

In a 13th Example, a system for transmitting data, comprising: a memory storing sets of orthogonal functions for each of a second, fourth, eighth, sixteenth, thirty-second, and sixty-fourth subcarriers in an orthogonal frequency division multiplexing bandwidth containing 64 subcarriers, wherein the sets of orthogonal functions are both internally and externally orthogonal; sets of coefficients stored in the memory, each set of coefficients corresponding to a symbol representing at least one bit of data; and a first processor for executing instructions on the memory, the instructions, when executed by the processor, configured to: encode, using the sets of orthogonal functions, data on each cycle of the second, fourth, eighth, sixteenth, thirty-second, and sixty-fourth subcarriers in a transmission interval; encode, using the set of functions, at least one additional subcarrier with data on each cycle of the at least one additional subcarrier in the transmission interval; and transmit the second, fourth, eighth, sixteenth, thirty-second, sixty-fourth, and the at least one additional subcarriers over a transmission interval.

In a 14th Example, the system of Example 13, further comprising: first and second bandpass filters; a second memory comprising second instructions thereon; and a second processor for executing the second instructions on the second memory, the second instructions, when executed by the second processor, configured to: receive, using the first bandpass filter, the second, fourth, eighth, sixteenth, thirty-second, sixty-fourth, and at least one additional subcarriers; and filter, using the second bandpass filter, the at least one additional subcarrier.

In a 15th Example, the system of Example 14, wherein the second instructions, when executed by the second processor, are further configured to: decode the set of orthogonal functions for each of the second, fourth, eighth, sixteenth, thirty-second, and sixty-fourth subcarriers; decode the set of functions for the at least one additional subcarrier; and combine the decoded data to recover the transmitted data.

In a 16th Example, the system of Example 15, wherein combining the decoded data to recover the transmitted data comprises combining the decoded data from each of the second, fourth, eighth, sixteenth, thirty-second, and sixty-fourth subcarriers.

In a 17th Example, the system of any of Examples 13-16, wherein combining the decoded data from each of the second, fourth, eighth, sixteenth, thirty-second, and sixty-fourth subcarriers comprises identifying common data from at least two of the second, fourth, eighth, sixteenth, thirty-second, or sixty-fourth subcarriers.

In a 18th Example, the system of any of Examples 13-17, wherein the at least one additional subcarrier carries a pilot signal.

In a 19th Example, the system of any of Examples 13-18, further comprising transmitting a guard interval.

In a 20th Example, the system of any of Examples 13-19, wherein the transmission interval is equal to one cycle of the lowest frequency subcarrier.

### Other Considerations

The above description is given by way of example, and not limitation. Given the above disclosure, one skilled in the art could devise variations that are within the scope and spirit of the invention disclosed herein, including various ways of forming the syntax of the text or natural language commands. Further, the various features of the embodiments disclosed herein can be used alone, or in varying combinations with each other and are not intended to be limited to the specific combination described herein. Thus, the scope of the claims is not to be limited by the illustrated embodiments.

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, Vx Works, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

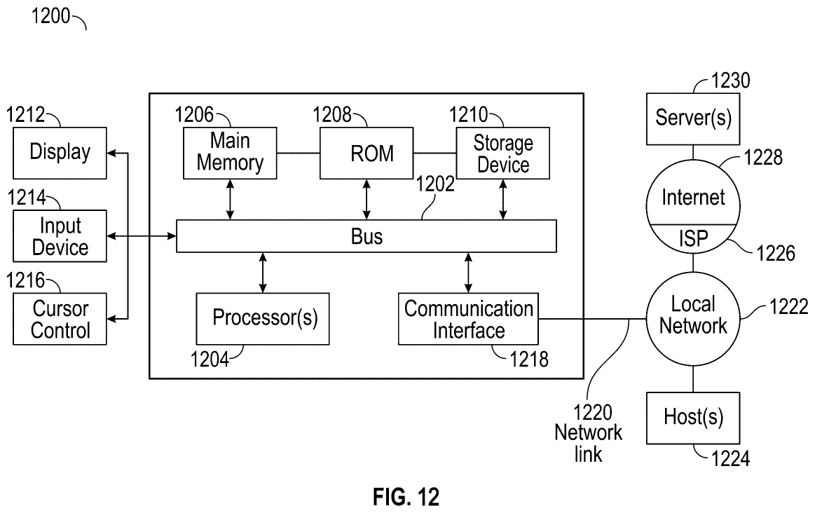

For example, FIG. 12 is a block diagram that illustrates a computer system 1200 upon which various embodiments may be implemented. For example, the computer system 1200 may be implemented as the graphical user interface 100 (FIG. 1) in some embodiments. Computer system 1200 includes a bus 1202 or other communication mechanism for communicating information, and a hardware processor, or multiple processors, 1204 coupled with bus 1202 for processing information. Hardware processor(s) 1204 may be, for example, one or more general purpose microprocessors.

Computer system 1200 also includes a main memory 1206, such as a random access memory (RAM), cache and/or other dynamic storage devices, coupled to bus 1202 for storing information and instructions to be executed by processor 1204. Main memory 1206 also may be used for storing temporary variables or other intermediate information during execution of instructions to be executed by processor 1204. Such instructions, when stored in storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204.

A storage device 1210, such as a magnetic disk, optical disk, or USB thumb drive (Flash drive), etc., is provided and coupled to bus 1202 for storing information and instructions.

Computer system 1200 may be coupled via bus 1202 to a display 1212, such as a cathode ray tube (CRT) or LCD display (or touch screen), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 1200 may include a user interface module to implement a GUI that may be stored in a mass storage device as computer executable program instructions that are executed by the computing device(s). Computer system 1200 may further, as described below, implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor(s) 1204 executing one or more sequences of one or more computer readable program instructions contained in main memory 1206. Such instructions may be read into main memory 1206 from another storage medium, such as storage device 1210. Execution of the sequences of instructions contained in main memory 1206 causes processor(s) 1204 to perform the process steps described herein. In alternative embodiments, hard-wired circuitry may be used in place of or in combination with software instructions.

Various forms of computer readable storage media may be involved in carrying one or more sequences of one or more computer readable program instructions to processor 1204 for execution. For example, the instructions may initially be carried on a magnetic disk or solid state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN (or WAN component to communicated with a WAN). Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A method for transmitting data using orthogonal frequency domain multiplexing, the method comprising:
identifying a lowest frequency subcarrier in an orthogonal frequency division multiplexing bandwidth comprising 64 subcarriers;
selecting the second, fourth, eighth, sixteenth, thirty-second, and sixty-fourth subcarriers in the orthogonal frequency division multiplexing bandwidth;
preparing a set of orthogonal functions for each of the second, fourth, eighth, sixteenth, thirty-second, and sixty-fourth subcarriers;
encoding, using the sets of orthogonal functions, data on each cycle of the second, fourth, eighth, sixteenth, thirty-second, and sixty-fourth subcarriers with data in a transmission interval;
transmitting the second, fourth, eighth, sixteenth, thirty-second, and sixty-fourth subcarriers over a transmission interval;
receiving the second, fourth, eighth, sixteenth, thirty-second, and sixty-fourth subcarriers using a bandpass filter;
decoding the set of orthogonal functions for each of the second, fourth, eighth, sixteenth, thirty-second, and sixty-fourth subcarriers; and
combining the decoded data to recover the transmitted data.

2. The method of claim 1, wherein at least one additional subcarrier carries a pilot signal.

3. The method of claim 1, wherein each set of orthogonal functions is both internally orthogonal and externally orthogonal.

4. The method of claim 1, wherein the transmission interval comprises, for each subcarrier frequency, a number of cycles corresponding to the interval of one cycle of the lowest frequency subcarrier.

5. The method of claim 1, further comprising transmitting a guard interval.

6. The method of claim 1, wherein combining the decoded data to recover the transmitted data comprises combining the decoded data from each of the second, fourth, eighth, sixteenth, thirty-second, and sixty-fourth subcarriers.

7. The method of claim 6, wherein combining the decoded data from each of the second, fourth, eighth, sixteenth, thirty-second, and sixty-fourth subcarriers comprises identifying common data from at least two of the second, fourth, eighth, sixteenth, thirty-second, or sixty-fourth subcarriers.

8. A method for transmitting data, comprising:
defining a set of 64 subcarriers in order to form an orthogonal frequency division multiplexing bandwidth;
identifying a lowest frequency subcarrier in the orthogonal frequency division multiplexing bandwidth, setting a transmission interval equal to one cycle of the lowest frequency subcarrier;
selecting the second, fourth, eighth, sixteenth, thirty-second, and sixty-fourth subcarriers and at least one additional subcarrier in the orthogonal frequency division multiplexing bandwidth;
preparing a set of orthogonal functions for each of the second, fourth, eighth, sixteenth, thirty-second, and sixty-fourth subcarriers, each set of orthogonal functions being both internally orthogonal and externally orthogonal;
preparing a set of functions for the at least one additional subcarrier; encoding, using the sets of orthogonal functions, data on every cycle of the
second, fourth, eighth, sixteenth, thirty-second, and sixty-fourth subcarriers in the transmission interval;
encoding, using the set of functions, the at least one additional subcarrier with data on each cycle of the at least one additional subcarrier in the transmission interval;
transmitting the second, fourth, eighth, sixteenth, thirty-second, sixty-fourth, and at least one additional subcarriers over a transmission interval;
receiving the second, fourth, eighth, sixteenth, thirty-second, sixty-fourth, and at least one additional subcarriers using a first bandpass filter;
filtering the at least one additional subcarrier using a second bandpass filter; decoding the set of orthogonal functions for each of the second, fourth,
eighth, sixteenth, thirty-second, and sixty-fourth subcarriers;
decoding the set of functions for the at least one additional subcarrier; and signal combining the decoded data to recover the transmitted data.

9. The method of claim 8, wherein the at least one additional subcarrier carries a pilot.

10. The method of claim 8, wherein each set of orthogonal functions is both internally orthogonal and externally orthogonal.

11. The method of claim 8, further comprising transmitting a guard interval.

12. The method of claim 8, wherein combining the decoded data to recover the transmitted data comprises combining the decoded data from each of the second, fourth, eighth, sixteenth, thirty-second, and sixty-fourth subcarriers.

13. A system for transmitting data, comprising:
a memory storing sets of orthogonal functions for each of a second, fourth, eighth, sixteenth, thirty-second, and sixty-fourth subcarriers in an orthogonal frequency division multiplexing bandwidth containing 64 subcarriers, wherein the sets of orthogonal functions are both internally and externally orthogonal;
sets of coefficients stored in the memory, each set of coefficients corresponding to a symbol representing at least one bit of data; and
a first processor for executing instructions on the memory, the instructions, when executed by the processor, configured to:
encode, using the sets of orthogonal functions, data on each cycle of the second, fourth, eighth, sixteenth, thirty-second, and sixty-fourth subcarriers in a transmission interval;
encode, using the set of functions, at least one additional subcarrier with data on each cycle of the at least one additional subcarrier in the transmission interval; and
transmit the second, fourth, eighth, sixteenth, thirty-second, sixty-fourth, and the at least one additional subcarriers over a transmission interval.

14. The system of claim 13, further comprising: first and second bandpass filters;
a second memory comprising second instructions thereon; and
second processor for executing the second instructions on the second memory, the second instructions, when executed by the second processor, configured to:
receive, using the first bandpass filter, the second, fourth, eighth, sixteenth, thirty-second, sixty-fourth, and at least one additional subcarriers; and
filter, using the second bandpass filter, the at least one additional subcarrier.

15. The system of claim 14, wherein the second instructions, when executed by the second processor, are further configured to:
decode the set of orthogonal functions for each of the second, fourth, eighth, sixteenth, thirty-second, and sixty-fourth subcarriers;
decode the set of functions for the at least one additional subcarrier; and combine the decoded data to recover the transmitted data.

16. The system of claim 15, wherein combining the decoded data to recover the transmitted data comprises combining the decoded data from each of the second, fourth, eighth, sixteenth, thirty-second, and sixty-fourth subcarriers.

17. The system of claim 13, wherein combining the decoded data from each of the second, fourth, eighth, sixteenth, thirty-second, and sixty-fourth subcarriers comprises identifying common data from at least two of the second, fourth, eighth, sixteenth, thirty-second, or sixty-fourth subcarriers.

18. The system of claim 13, wherein the at least one additional subcarrier carries a pilot signal.

19. The system of claim 13, further comprising transmitting a guard interval.

20. The system of claim 13, wherein the transmission interval is equal to one cycle of the lowest frequency subcarrier.
